(19) United States
(12) Patent Application Publication
(10) Pub. No.: US 2026/0008070 A1
(43) Pub. Date: Jan. 8, 2026

(54) ROTARY NOZZLE WITH THIN FLUID FILM SEAL

(71) Applicant: STONEAGE, INC., Durango, CO (US)

(72) Inventors: Joseph A. SCHNEIDER, Durango, CO (US); Timothy M. D. TORMEY, Hesperus, CO (US)

(21) Appl. No.: 19/260,052

(22) Filed: Jul. 3, 2025

Related U.S. Application Data
(60) Provisional application No. 63/667,466, filed on Jul. 3, 2024.
(60) Provisional application No. 63/819,442, filed on Jun. 6, 2025.

(51) Int. Cl. B05B 3/06; B05B 12/00

(52) U.S. Cl. CPC B05B 3/06; B05B 12/002

(57) ABSTRACT

A nozzle apparatus assembly including a housing body and a nozzle head connected to a nozzle shaft rotatably mounted within the housing body. The nozzle shaft and the nozzle head define a primary fluid flow path extending from an inlet end of the shaft to a set of directional nozzles disposed at a discharge end of the nozzle head, and the nozzle shaft and the nozzle head are configured to rotate together in response to a pressurized liquid conveyed through the primary fluid flow path and discharged from the set of directional nozzles. The nozzle apparatus assembly also includes a secondary fluid flow path in fluid communication with the primary fluid flow path. The secondary fluid flow path passes between a rotational interface dimensioned to contain a thin fluid film with a pressure gradient that decreases radially outwardly.

### CROSS-REFERENCE TO RELATED APPLICATION

This application claims the benefit of U.S. Provisional Application No. 63/819,442, filed on Jun. 6, 2025, entitled “Rotary Nozzle With Thin Fluid Film Seal,” and claims the benefit of U.S. Provisional Application No. 63/667,466, filed on Jul. 3, 2024, entitled “Rotary Nozzle with Thin Fluid Film Seal, the technical disclosures of which are hereby incorporated by reference in their entirety.

### BACKGROUND

### Technical Field

Novel aspects of the present disclosure relate to the field of high-pressure fluid spraying applications, and more particularly to a rotary nozzle assembly for spraying high-pressure liquids and having a thin fluid film forming a high-pressure seal to reduce mechanical wear of components.

### Description of Related Art

In the field of high-pressure rotary liquid handling devices where the operating parameters can include pressures up to 55,000 pounds per square inch (PSI), rotating speeds of 5,000 revolutions per minute (RPM) and flow rates of 25 gallons per minute (GPM), operating parameters relating to construction, cost, durability and ease of maintenance of rotating nozzles present many problems. High pressure water jet cleaning devices utilizing reaction force rotary nozzles used in industrial applications, such as surface preparation or cleaning operations, tend to rotate at very high speeds. High speed rotation of nozzle components in the presence of high-pressure cleaning fluid can increase the mechanical wear of the nozzle components, reducing the service life of the rotating nozzles. For example, mechanical seals disposed at a rotational interface of nozzle components exposed to high speed and high pressure require frequent replacement due to mechanical wear. Accordingly, a need exists for a non-mechanical means of prolonging the mechanical integrity of rotating components and for mitigating the effects of mechanical wear.

### BRIEF SUMMARY

Novel aspects of the present disclosure are directed to a nozzle apparatus that includes a housing body and a nozzle head connected to a nozzle shaft rotatably mounted within the housing body. The nozzle shaft and the nozzle head define a primary fluid flow path extending from an inlet end of the shaft to a set of directional nozzles disposed at a discharge end of the nozzle head, and the nozzle shaft and the nozzle head are configured to rotate together in response to a pressurized liquid conveyed through the primary fluid flow path and discharged from the set of directional nozzles. The nozzle apparatus assembly also includes a secondary fluid flow path in fluid communication with the primary fluid flow path. The secondary fluid flow path passes between a rotational interface dimensioned to contain a thin fluid film with a pressure gradient that decreases radially outwardly.

Other aspects, embodiments and features of the invention will become apparent from the following detailed description of the invention when considered in conjunction with the accompanying figures. In the figures, each identical, or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention.

### BRIEF DESCRIPTION OF THE DRAWINGS

The preceding aspects and many of the attendant advantages of the present technology will become more readily appreciated by reference to the following Detailed Description when taken in conjunction with the accompanying simplified drawings of example embodiments. The drawings briefly described below are presented for ease of explanation and do not limit the scope of the claimed subject matter.

FIG. 1 is a perspective view of a nozzle apparatus assembly in accordance with an illustrative embodiment.

FIG. 2 is a cross-sectional view of the nozzle apparatus assembly of FIG. 1 in accordance with an illustrative embodiment.

FIG. 3 is an exploded view of the nozzle apparatus assembly in accordance with an illustrative embodiment.

FIG. 4 is an exploded rear perspective view of the nozzle apparatus assembly in accordance with an illustrative embodiment.

FIG. 5 is an enlarged, cross-sectional view of an inlet end of the nozzle apparatus assembly of FIG. 1 in accordance with an illustrative embodiment.

FIG. 6 is an enlarged, cross-sectional view of a spool and surrounding structures of the nozzle apparatus assembly of FIG. 1 in accordance with an illustrative embodiment.

FIG. 7 is a perspective view of an alternative embodiment of a nozzle apparatus assembly.

FIG. 8 is a cross-sectional view of the nozzle apparatus assembly of FIG. 7 in accordance with an illustrative embodiment.

FIG. 9 is an exploded view of the nozzle apparatus assembly depicted in FIG. 7 in accordance with an illustrative embodiment.

FIG. 10 is an exploded front perspective view of the nozzle apparatus assembly depicted in FIG. 7 in accordance with an illustrative embodiment.

FIG. 11 is an enlarged, cross-sectional view of the inlet end of the nozzle apparatus assembly depicted in FIG. 7 in accordance with an illustrative embodiment.

FIG. 12 is an enlarged, cross-sectional view of a stem, mechanical seal, and surrounding structures of the nozzle apparatus assembly depicted in FIG. 7 in accordance with an illustrative embodiment.

FIG. 13 is a perspective view of an alternate embodiment of a nozzle apparatus assembly in accordance with an illustrative embodiment.

FIG. 14 is a cross-sectional view of the nozzle apparatus assembly depicted in FIG. 13.

FIG. 15 is an enlarged, cross-sectional view of the inlet end of the nozzle apparatus assembly depicted in FIG. 14.

FIG. 16 is a side view of the nozzle apparatus assembly depicted in FIG. 13.

FIG. 17 is an exploded view of the nozzle apparatus assembly depicted in FIG. 16.

FIG. 18 is an exploded, perspective view of the nozzle apparatus assembly depicted in FIG. 16.

FIG. 19 is another exploded, perspective view of the nozzle apparatus assembly depicted in FIG. 16.

FIG. 20 is an exploded, side view of the braking assembly and data logger of the nozzle apparatus assembly in accordance with an illustrative embodiment.

FIG. 21 is an exploded, perspective view of the braking assembly and data logger of the nozzle apparatus assembly in accordance with an illustrative embodiment.

FIG. 22 is another exploded, perspective view of the braking assembly and data logger of the nozzle apparatus assembly in accordance with an illustrative embodiment.

FIG. 23 is a partially exploded view of the inlet end of the nozzle shaft, the keeper ring, and the flat face labyrinth seals in accordance with an illustrative embodiment.

FIG. 24 is a cross-sectional view of the inlet end of the nozzle shaft, the keeper ring, and the flat face labyrinth seals in accordance with an illustrative embodiment.

### DETAILED DESCRIPTION

The various embodiments of a nozzle apparatus assembly described in this disclosure are intended for use in high-pressure ranges, e.g., between about 2,000-55,000 PSI at high rates of rotation, e.g., between about 500-5,000 RPM. Components of a nozzle assembly apparatus rotating at high speeds while exposed to high pressure fluid suffer increased rates of mechanical wear, particularly at rotational interfaces, i.e., an interface between a stationary surface and a rotating surface or between two rotating surfaces that may rotate at different speeds. Additionally, mechanical wear at conventional seals will increase maintenance needs.

Novel aspects of the present disclosure recognize the need for reducing the rate of mechanical wear at the rotational interfaces and for mitigating the effects of worn components. Thus, objects of the disclosure provide a secondary fluid flow path through the nozzle apparatus assembly that can contain thin fluid films and reduce the liquid pressure at rotational interfaces for reducing mechanical wear. Another object of the invention is to provide dynamic sealing-via a spool or mechanical seal-along the secondary fluid flow path to mitigate the effect of mechanical wear.

In the disclosure that follows, the nozzle apparatus assembly may be described with relative terms such as “inlet end” and “discharge end”. As used herein, pressurized liquid is introduced to the nozzle apparatus assembly at the “inlet end” and discharged from the “discharge end”. In addition, the term “upstream” and “downstream” are relative terms that may be used to describe an orientation relative to a direction of fluid flow. Thus, a fluid flow path proceeding directly from the inlet end to the discharge end may have an upstream end at the inlet end and a downstream end at the discharge end. Further, a component of the nozzle apparatus assembly disposed in a fluid flow path or which defines a boundary of a fluid flow path may be described as having an upstream end or a downstream end based on a direction of fluid flowing past.

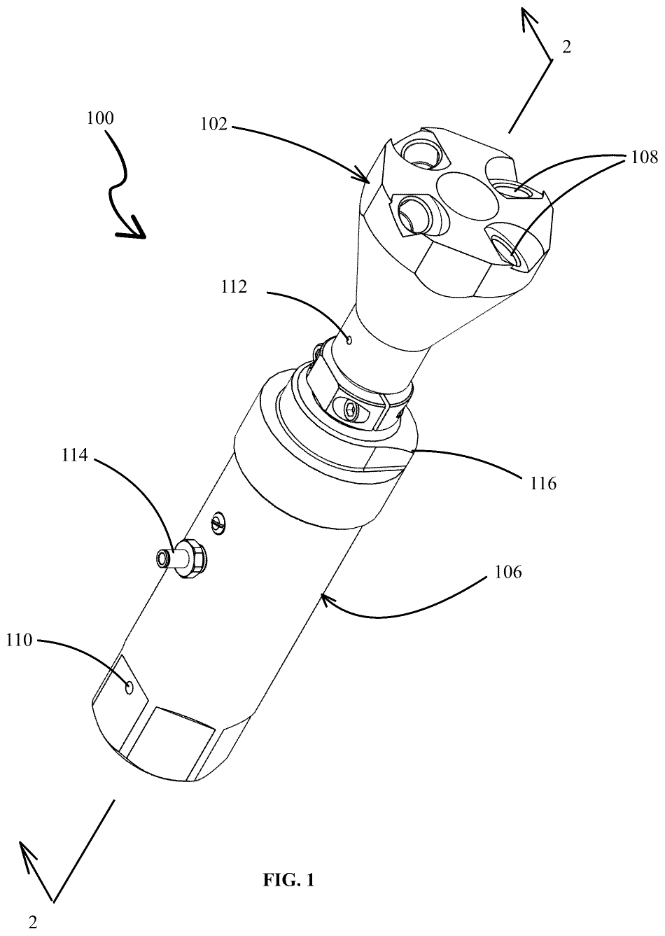

A nozzle apparatus assembly 100 according to a first embodiment of this disclosure is depicted and described in FIGS. 1-6. The nozzle apparatus assembly 100 has a primary fluid flow path 107 that carries a pressurized liquid from its inlet end to its outlet end for use in cleaning operations. The nozzle apparatus assembly 100 also includes a secondary fluid flow path 109 that reduces the mechanical wear of the nozzle apparatus assembly 100 and a dynamically repositionable spool 600 that can help maintain the dimensions of the secondary fluid flow path 109 as the rotational interfaces experience mechanical wear.

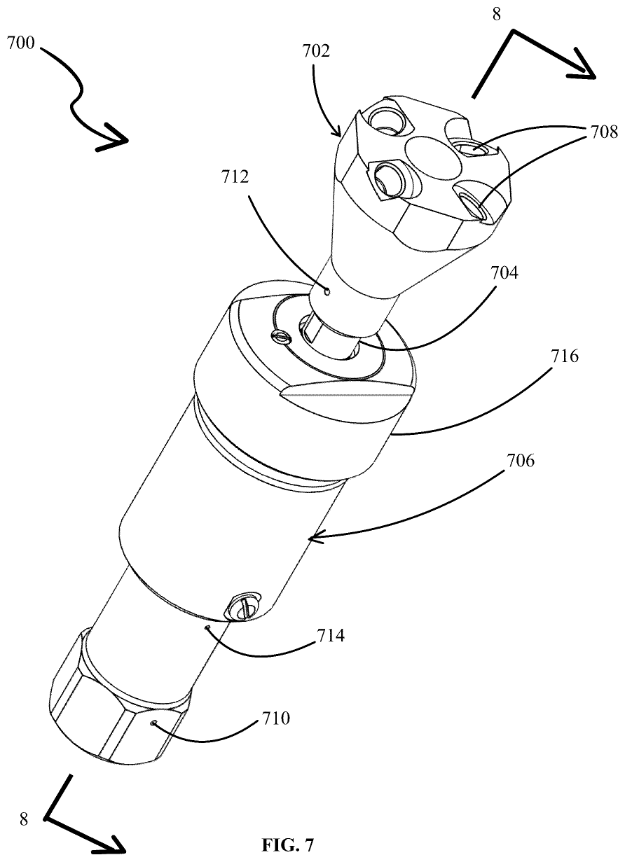

A nozzle apparatus assembly 700 according to a second embodiment of this disclosure is depicted and described in FIGS. 7-12. The nozzle apparatus assembly 700 has a primary fluid flow path 707 that carries a pressurized liquid from an inlet end of the nozzle apparatus assembly 700 to the outlet end for use in cleaning operations. The nozzle apparatus assembly 700 also includes a secondary fluid flow path 709 that reduces the mechanical wear of the nozzle apparatus assembly 700 and a mechanical seal 900 in facing engagement with a sleeve 724 and biased towards the sleeve 724 to help maintain the dimensions of the secondary fluid flow path 709 as the rotational interfaces experience mechanical wear.

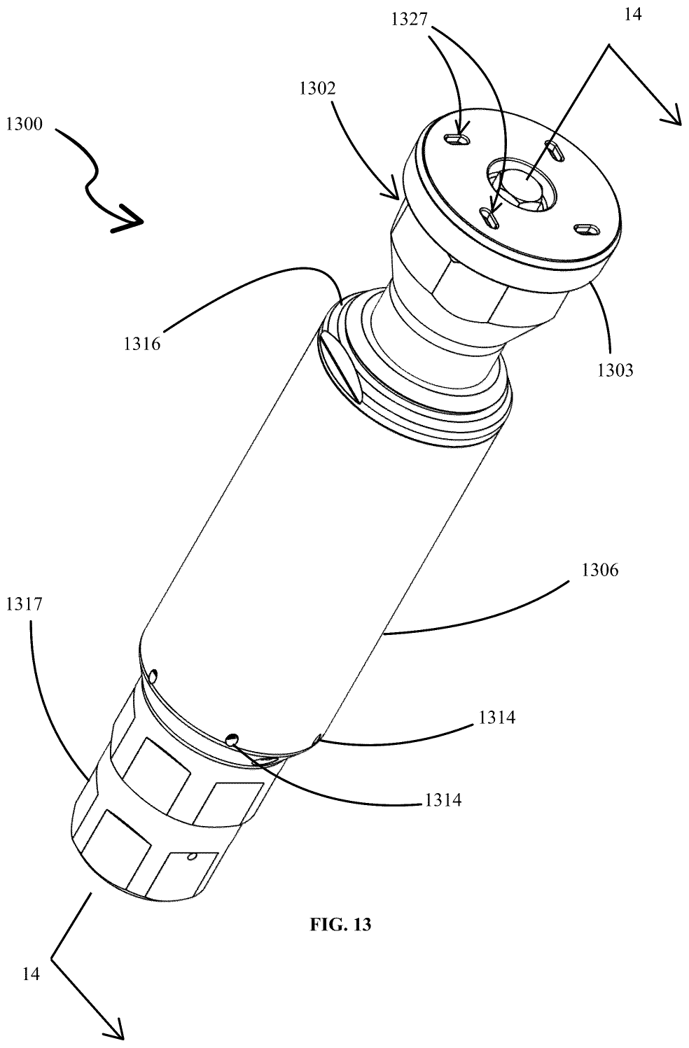

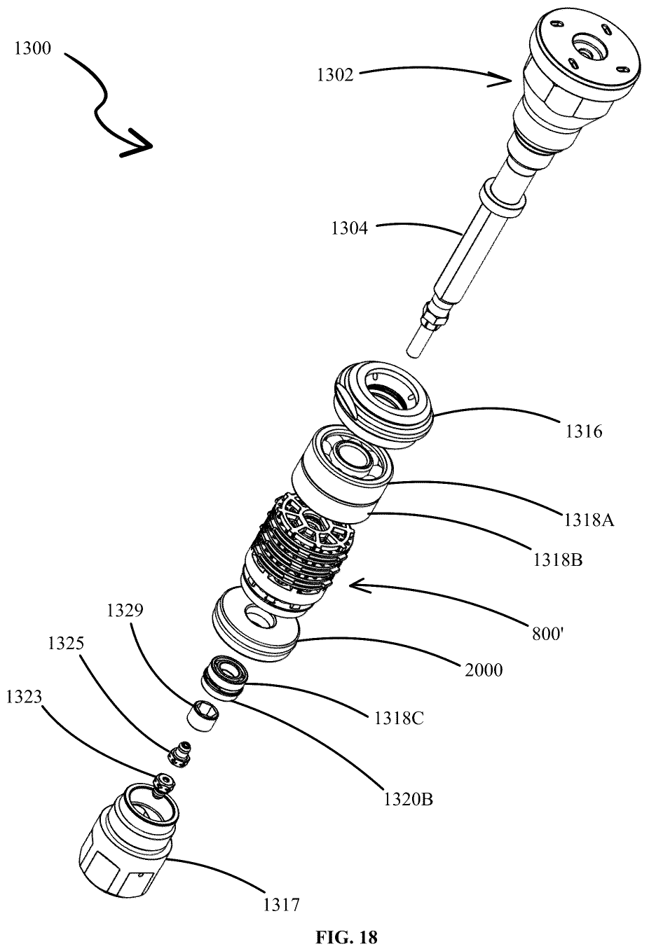

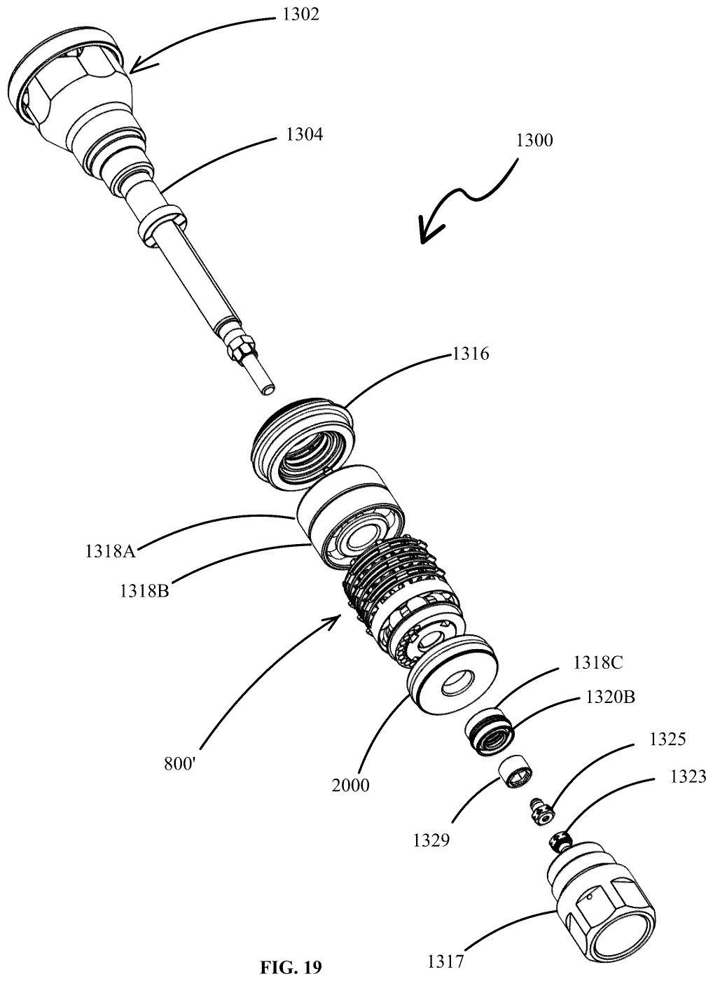

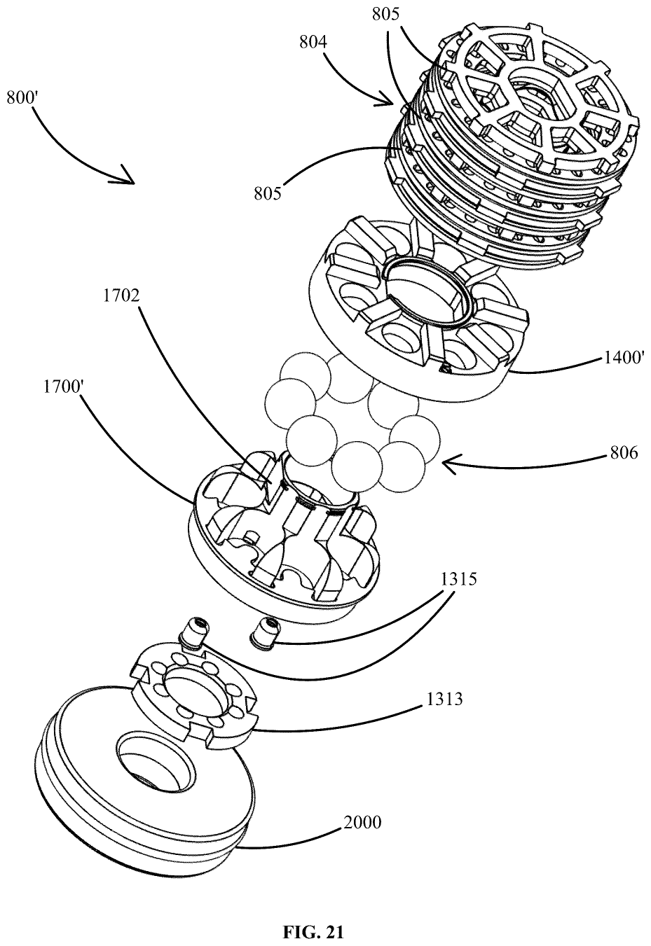

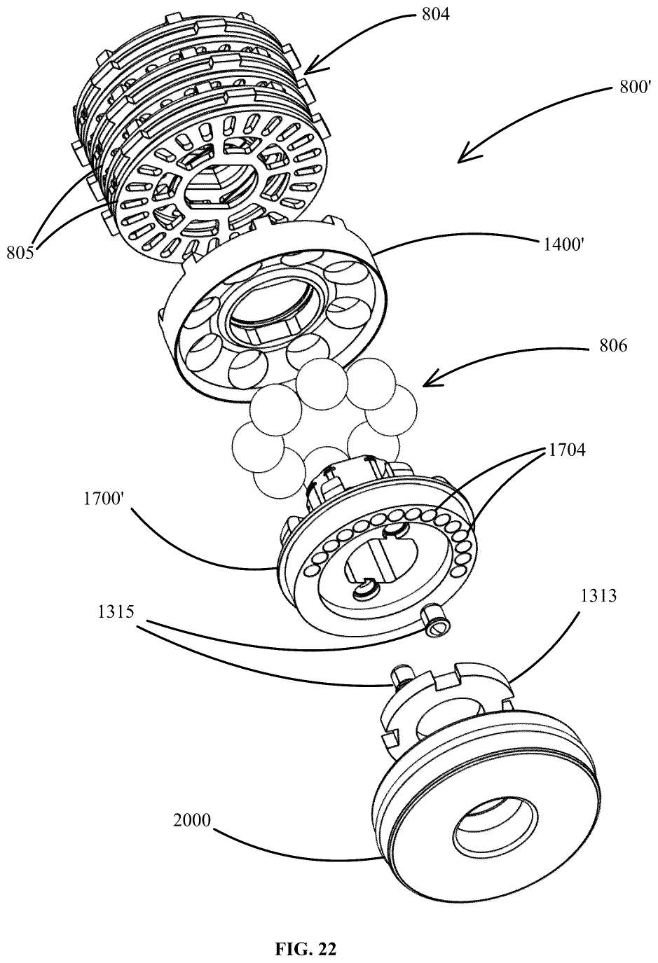

A nozzle apparatus assembly 1300 according to a third embodiment of this disclosure is depicted and described in FIGS. 13-22. The nozzle apparatus assembly 1300 has a primary fluid flow path 1307 that carries a pressurized liquid from an inlet end of the nozzle apparatus assembly 1300 to the outlet end for use in cleaning operations. The nozzle apparatus assembly 1300 also includes a secondary fluid flow path 1309 that passes between a pair of flat face labyrinth seals 1323 and 1325, which reduces the mechanical wear of the nozzle apparatus assembly 1300. The upstream flat face labyrinth seal is biased towards the downstream flat face labyrinth seal to help maintain the dimensions of the secondary fluid flow path 1309 as the rotational interfaces experience mechanical wear.

### First Illustrative Embodiment

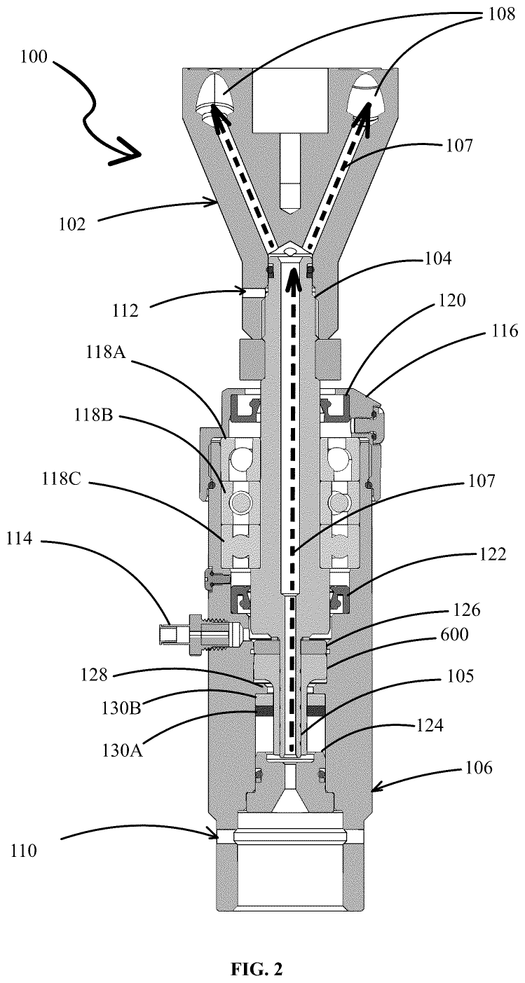

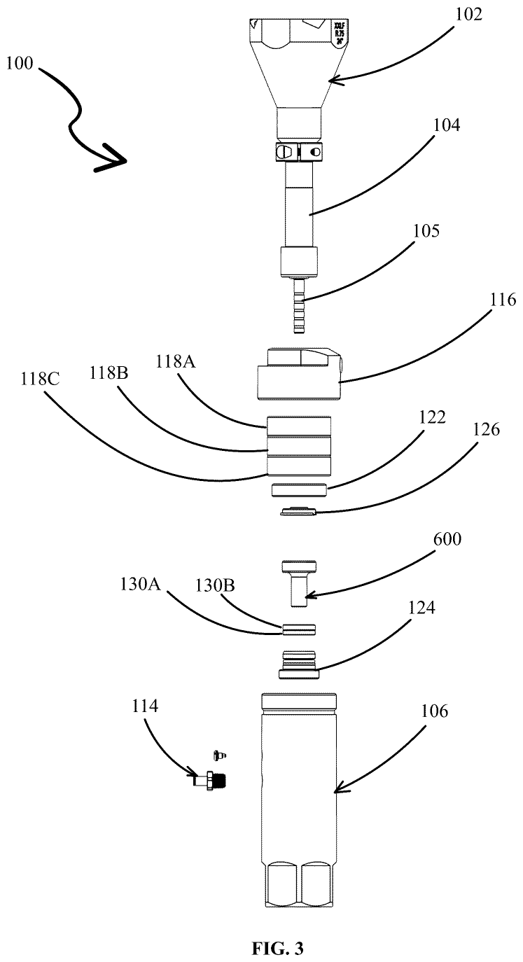

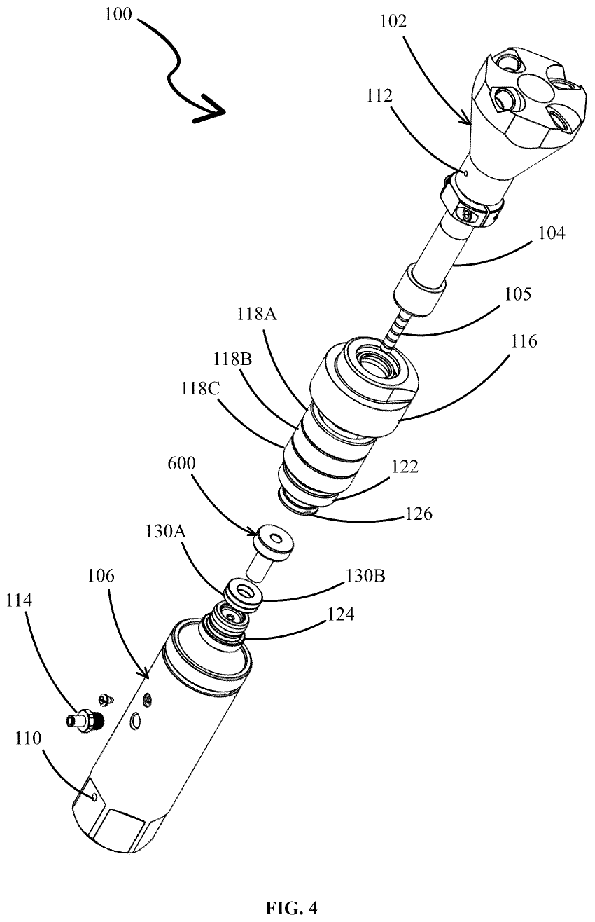

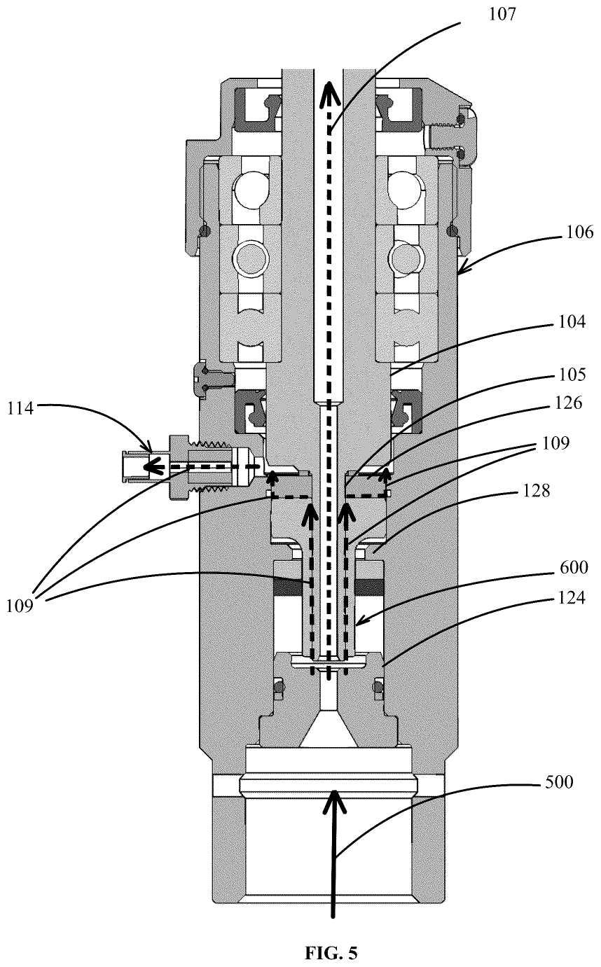

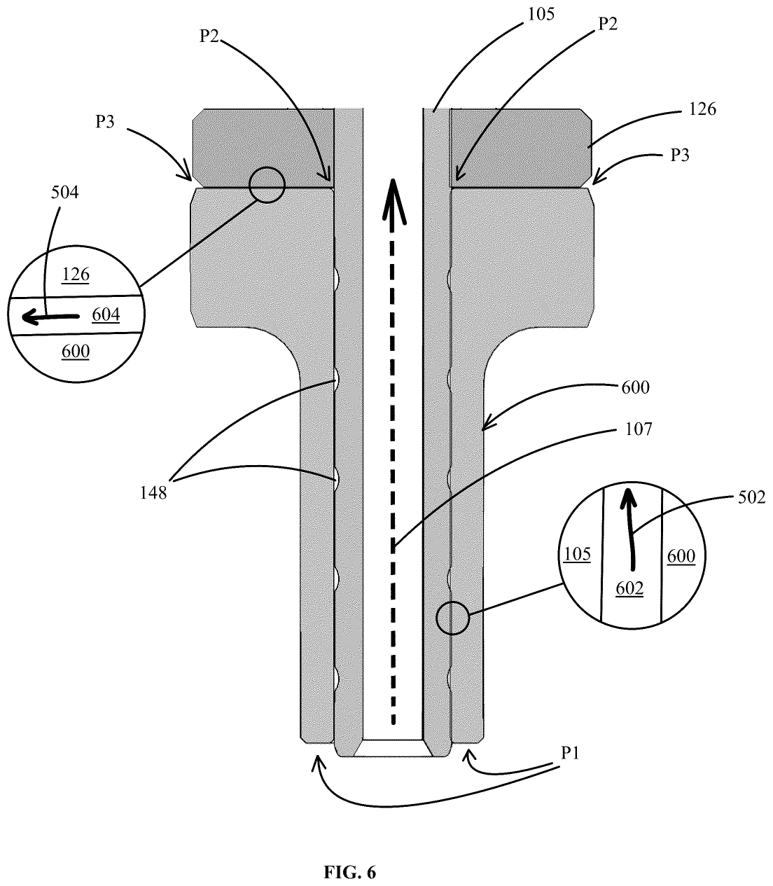

FIGS. 1-6 depict the nozzle apparatus assembly according to a first illustrative embodiment. In particular, FIG. 1 is a perspective view of a nozzle apparatus assembly 100 in accordance with an illustrative embodiment. FIG. 2 is a cross-sectional view of the nozzle apparatus assembly 100 of FIG. 1, taken along line 2-2. FIG. 3 illustrates an exploded view of the nozzle apparatus assembly 100, and FIG. 4 illustrates an exploded, rear perspective view of the nozzle apparatus assembly 100. FIG. 5 is an enlarged, cross-sectional view of an inlet end of the nozzle apparatus assembly 100, and FIG. 6 is an enlarged, cross-sectional view of a spool and surrounding structures of the nozzle apparatus assembly 100 in accordance with an illustrative embodiment.

The exemplary nozzle apparatus 100 depicted in FIG. 1 includes an elongated cylindrical housing body 106, within which is rotatably mounted a tubular nozzle shaft 104 that is shown in more detail in FIGS. 2-6. The tubular nozzle shaft 104 is fixedly attached to a nozzle head 102 so that rotation of the nozzle head 102 causes rotation of the tubular nozzle shaft 104. Rotation of the nozzle head 102 is caused by the discharge of pressurized liquid, i.e., jet streams, from a set of canted discharge nozzles 108. As used herein, the term “set” means one or more. Thus, the set of discharge nozzles 108 can be a single discharge nozzle or two or more discharge nozzles. In the non-limiting embodiment presented in FIGS. 1-6 of this disclosure, the set of discharge nozzles 108 includes four discharge nozzles 108 regularly arranged about the discharge end of the nozzle head 102. The set of discharge nozzles 108 are canted to impart a jet reaction torque, i.e., rotation, on the nozzle head 102 and also on the tubular nozzle shaft 104, which makes the nozzle head 102 and the tubular nozzle shaft 104 self-rotating. The direction of self-rotation in this illustrated embodiment is clockwise when looking into the discharge end of the nozzle assembly 100. The direction of rotation helps to maintain the nozzle head 102 screwed securely into the tubular nozzle shaft 104.

Pressurized liquid introduced into the inlet end of the nozzle apparatus assembly 100 is discharged from the nozzle apparatus assembly 100 from the set of discharge nozzles 108 of the nozzle head 102. Liquid may also escape from the nozzle apparatus assembly 100 from one or more of the weep passages, e.g., weep passages 110 and 112, due to failure of an O-ring, a loose inlet connection, etc. Some of the pressurized fluid can escape from the nozzle apparatus assembly via discharge port 114, which provides an outlet for pressurized liquid flowing through a secondary fluid flow path 109 that is shown in more detail in FIG. 5. The secondary fluid flow path 109 is configured to reduce the mechanical wear at the rotational interfaces by containing thin fluid films and by providing decreased pressure at the rotational interfaces, as shown and described in FIG. 6. In the non-limiting embodiment of the nozzle apparatus assembly 100 depicted in FIGS. 1-6, the discharge port 114 may be removably secured to the housing 106 via a threaded interface and sealed by a cap.

With reference now to the cross-sectional view of the nozzle apparatus assembly 100 depicted in FIG. 2, the nozzle head 102 is shown fixedly mounted to the tubular nozzle shaft 104, which is in turn rotatably mounted within the housing 106 on a set of bearings, e.g., bearings 118A, 118B, 118C (referred to collectively as “bearings 118”). The axial position of the set of bearings 118 is maintained by an inwardly extending shoulder of the housing body 106 and the inside surface of the cap 116 that seals the discharge end of the housing body 106. In the embodiment depicted in FIG. 2, the set of bearings 118 are located between seal 120 and seal 122, which are positioned to prevent the inflow of cleaning fluid from contacting and fouling the set of bearings 118 and/or prevent the escape of lubricating fluid from the nozzle assembly apparatus 100.

A source of pressurized liquid, e.g., a fluid hose or lance, (not shown) can be coupled to the inlet end of the housing body 106 by conventional means, including but not limited to a cone-and-thread connector or conventional pipe threads. In the non-limiting embodiment in FIG. 2, the nozzle apparatus assembly 100 includes an inlet seat housing 124 that provides a connection interface with a terminal end of the source of pressurized liquid. The inlet seat housing 124 is shown as a smooth, conical surface configured to engage a cone-and-thread connector but can take any one or more different configurations in alternate embodiments.

Pressurized liquid introduced into the nozzle apparatus assembly 100 via the inlet seat housing 124 is conveyed through a primary flow path 107 that extends through the tubular nozzle shaft 104, and through passages formed in the nozzle head 102 before being discharged through the discharge nozzles 108. The discharge of the pressurized liquid from the canted discharge nozzles 108 causes nozzle head 102 and tubular nozzle shaft 104 to rotate. At high operating pressures, the nozzle head 102 and tubular nozzle shaft 104 can rotate at high speeds, e.g., 5,000 RPMs or more, resulting in mechanical wear at the rotational interfaces. The mechanical wear can be reduced by fluid carried through the secondary fluid flow path 109.

The secondary fluid flow path 109, shown in more detail in FIG. 5, extends from the downstream end of the inlet seat housing 124, between a spool 600 and the stem 105, between the spool 600 and the seal retainer 126, and out of the nozzle assembly apparatus 100 from the discharge port 114. Pressurized liquid introduced through the inlet seat housing 124 and conveyed through the secondary fluid flow path 109 forms thin fluid films between the spool 600 and the stem 105 and also between the spool 600 and the seal retainer 126 to reduce frictional engagement of the surfaces at their respective rotational interfaces. Additionally, the pressurized liquid flowing through the secondary fluid flow path 109 has a generally decreasing pressure gradient along its length, resulting in at least the rotational interface between the seal retainer 126 and the spool 600 being exposed to lower operating pressures, which prolongs the service life of the nozzle apparatus assembly 100.

The spool 600 is generally funnel-shaped with a larger downstream end and a narrower upstream end. The spool 600 is engaged around a portion of the tubular nozzle shaft 104. In the non-limiting embodiment depicted in FIGS. 1-6, the tubular nozzle shaft 104 includes a narrower stem 105 that receives the spool 600. The stem 105 is shown to be integrally formed with the tubular nozzle shaft 104, but in another embodiment the stem 105 can be removably or fixedly attached to the tubular nozzle shaft 104. The larger end of the spool 600 is positioned between a seal retainer 126 and an inwardly extending annulus 128, both of which limit the axial travel of the spool 600 along the tubular nozzle shaft 104.

Fluid flow around the exterior surface of the spool 600 is controlled, at least in part by a set of seals 130 disposed around the spool 600. In particular, the set of seals 130 includes a first seal 130A and a second seal 130B that eliminates or at least reduces the fluid flow around the exterior surface of the spool 600 and instead promotes the flow of pressurized liquid through the secondary fluid flow path 109.

To mitigate the effects of mechanical wear at the rotational interface between the spool 600 and the seal retainer 126, the spool 600 is slidably engaged around the nozzle shaft 105, i.e., stem 105, and is exposed to the pressurized liquid flowing through the secondary fluid flow path 109. During operation, the relatively higher pressure exerted on its upstream end wall biases the spool 600 towards the seal retainer 126 to maintain the gap distance between the two surfaces despite the presence of mechanical wear.

With reference to FIG. 5, an enlarged, cross-sectional view of an inlet end of the nozzle apparatus assembly 100 is depicted. A pressurized cleaning fluid, represented by arrow 500, can be provided by a high-pressure liquid input source (not shown) coupled to the inlet seat housing 124. The cleaning fluid can be introduced at a pressure between about 2,000 PSI-55,000 PSI. The portion of the pressurized cleaning fluid traveling through the primary fluid flow path 107 discharged through the discharge nozzles 108 causes the tubular nozzle shaft 104 and the nozzle head 102 to rotate at a high rate of speed. The remaining portion of the pressurized cleaning fluid traveling through the secondary fluid flow path 109 is discharged through the discharge port 114 and forms a first thin fluid film, represented by arrow 502 in FIG. 6, in gap 602 and a second thin fluid film, represented by arrow 504 in FIG. 6, in gap 604. The pressure drop along the secondary fluid flow path 109, shown in the figure that follows, reduces the amount of pressure exerted at the rotational interfaces, e.g., between the seal retainer 126 and spool 600, which reduces mechanical wear.

FIG. 6 is an enlarged, cross-sectional view of the inlet end of the tubular nozzle shaft 104 showing the spool 600 engaged around the stem 105 and in facing engagement with the seal retainer 126. Pressurized liquid is introduced into the nozzle apparatus assembly 100 at the inlet seat housing 124 at a first pressure P1. The portion of the pressurized liquid flowing through the secondary fluid flow path 109 exerts a pressure of about Pl on the upstream end wall of the spool 600. As the pressurized liquid travels through the gap 602 between the stem 105 and the spool 600, the pressure decreases to a second pressure P2 at the transition between the first thin fluid film 502 and the second thin fluid film 504. The pressure of the pressurized liquid continues to decrease radially outwardly as it is conveyed through the gap 604 between the spool 600 and the seal retainer 126 and achieves a third pressure P3 before exiting from the nozzle apparatus assembly 100 from the discharge port 114. In a non-limiting embodiment where the inlet pressure P1 is about 40,000 PSI, the second pressure P2 is about 25,000 PSI, and the third pressure is about atmospheric pressure, i.e., 14.7 PSI.

In a non-limiting embodiment, the width of gaps 602 and 604 can be between 1/5,000-1/15,000 of an inch, or more particularly between 1/7,500-1/12,250 of an inch. In a particular embodiment, the width of gaps 602 and 604 is about 1/10,000 of an inch. The dimensions of the gap between the rotational surfaces allows for the formation of thin fluid films 502 and 504, eliminating or at least reducing the amount of contact between surfaces at rotational interfaces, which reduces the mechanical wear of the nozzle apparatus assembly 100. Further, the decreased water pressure at the rotational interfaces also reduces mechanical wear.

The tubular nozzle shaft 104 can include a plurality of recesses 148 spaced apart along the stem 105, which promotes non-laminar fluid flow in the gap 602 between the stem 105 and the spool 600, which reduces the drag along the surfaces between the stem 105 and the spool 600. In the depicted embodiment, the plurality of recesses 148 are annular recesses, but can take a different shape in other embodiments, e.g., dimpled shape like the exterior surface of golf balls.

In the embodiment depicted in FIGS. 1-6, the nozzle apparatus assembly 100 includes a seal retainer 126 between a shoulder of the nozzle shaft 104 and the spool 600; however, in another embodiment, the seal retainer 126 can be omitted so that the spool 600 is in facing engagement with the shoulder of the nozzle shaft 104. In this other embodiment, the secondary fluid flow path 109 passes between the spool 600 and the shoulder of the nozzle shaft 104 before exiting from the discharge port 114. In addition, the stem 105 is shown to be integrally formed with the nozzle shaft 104, but in another embodiment the stem 105 can be integrally formed with the inlet seat housing 124, fixedly attached to the inlet seat housing 124, or removably attached to the inlet seat housing 124. In this other embodiment, the spool 600 can be rotationally fixed to the nozzle shaft 104 so that the secondary fluid flow path proceeds between the inlet seat housing 124 and the spool 600.

### Second Illustrative Embodiment

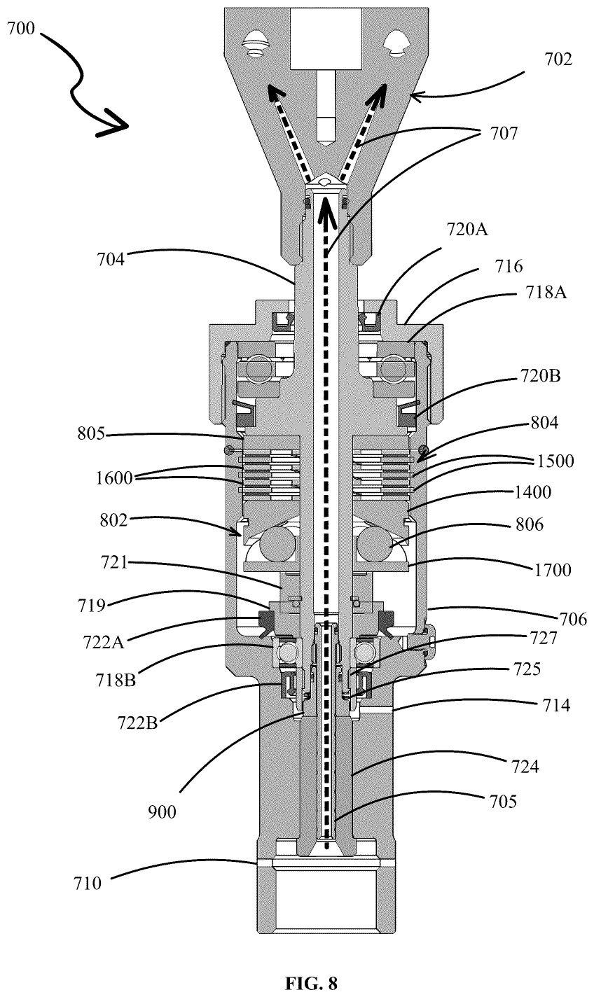

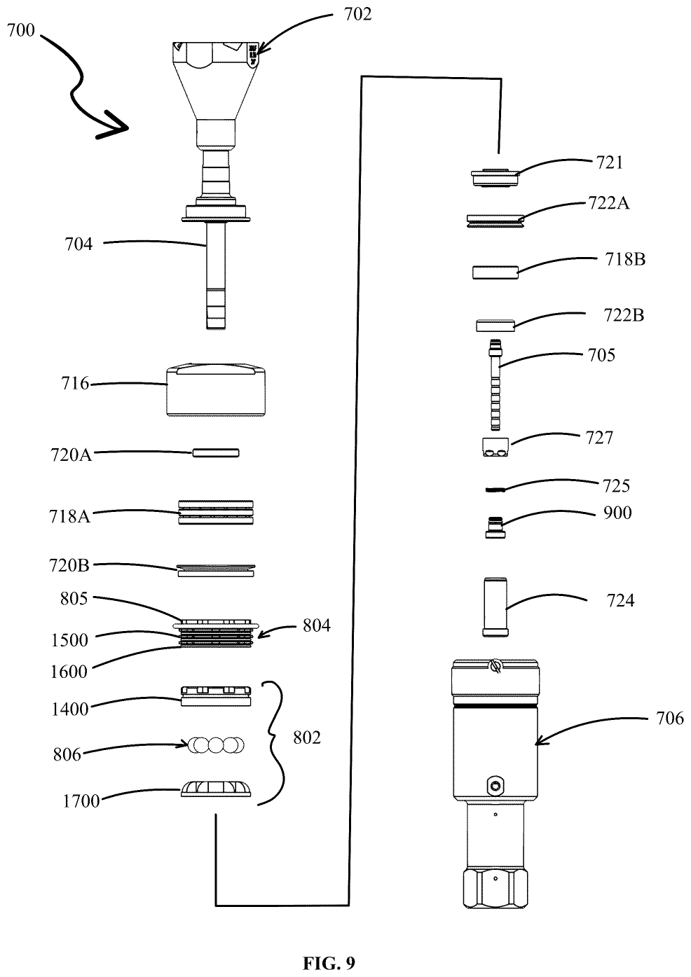

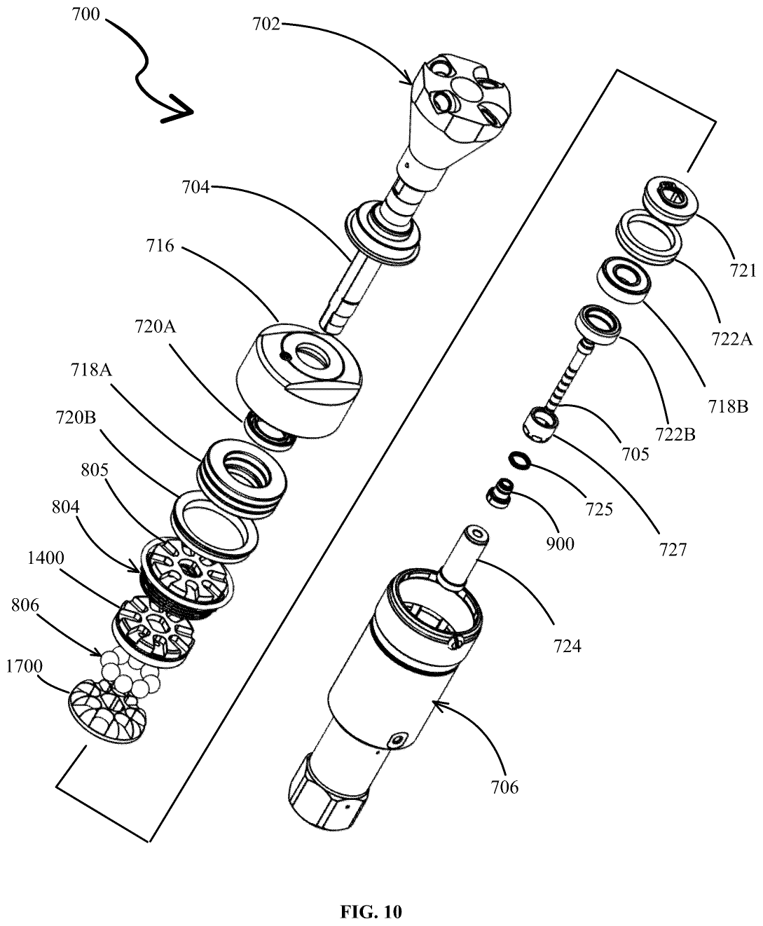

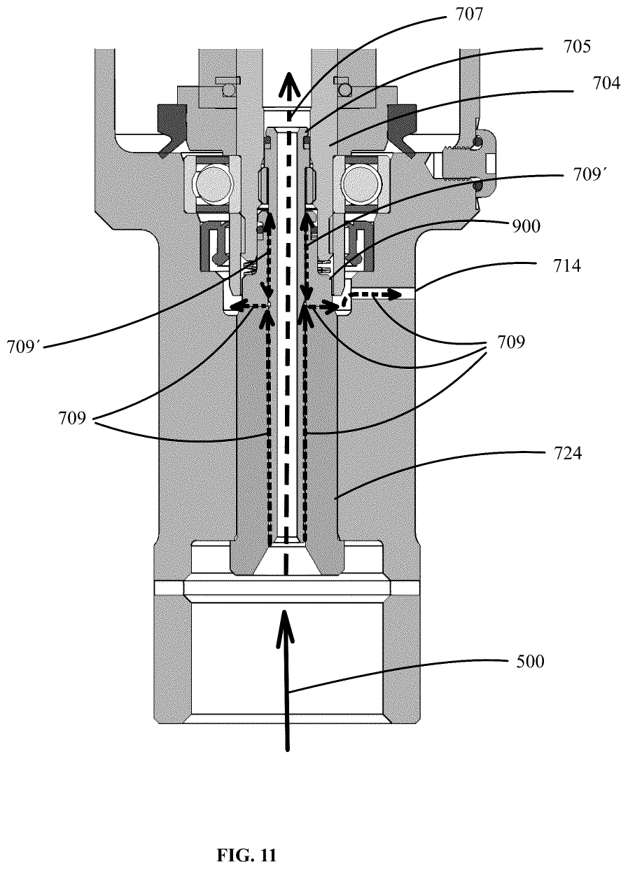

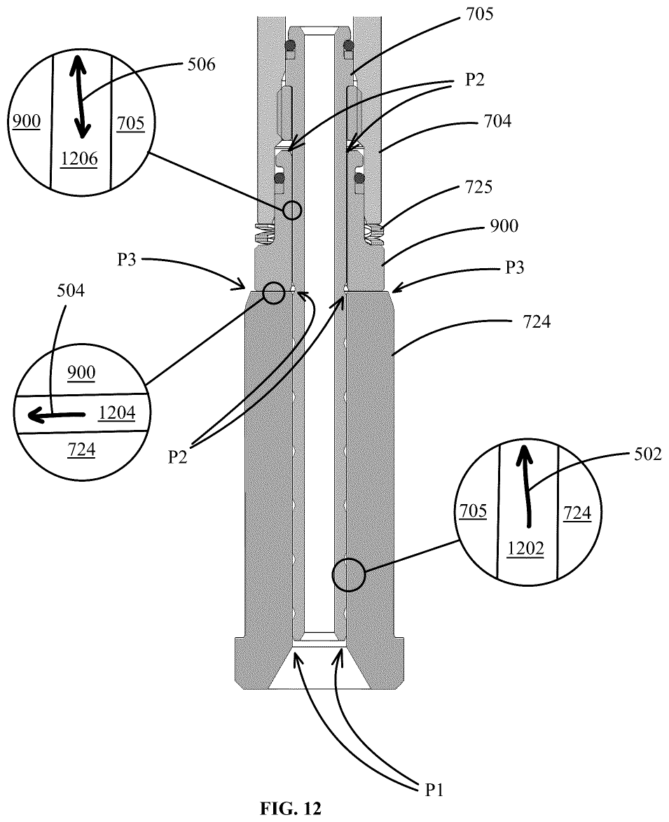

FIGS. 7-12 depict a nozzle apparatus assembly according to a second illustrative embodiment. FIG. 7 is a perspective view of a nozzle apparatus assembly 700, in accordance with the second illustrative embodiment. FIG. 8 is a cross-sectional view of the nozzle apparatus assembly 700 of FIG. 7, taken along line 8-8. FIG. 9 illustrates an exploded view of the nozzle apparatus assembly 700, and FIG. 10 illustrates an exploded front perspective view of the nozzle apparatus assembly 700. FIG. 11 is an enlarged, cross-sectional view of an inlet end of the nozzle apparatus assembly 700, and FIG. 12 is an enlarged, cross-sectional view of a stem, a mechanical seal, and surrounding structures of the nozzle apparatus assembly 700 in accordance with an illustrative embodiment.

Turning to FIG. 7, an alternative embodiment of a nozzle apparatus assembly 700 is depicted. The nozzle apparatus 700 includes an elongated cylindrical housing body 706, within which is rotatably mounted a tubular nozzle shaft 704 that is shown in more detail in FIGS. 7-12. The tubular nozzle shaft 704 is fixedly attached to a nozzle head 702 so that rotation of the nozzle head 702 causes rotation of the tubular nozzle shaft 704. Rotation of the nozzle head 702 is caused by the discharge of pressurized liquid, i.e., jet streams, from a set of canted discharge nozzles 708. In the non-limiting embodiment presented in FIGS. 7-6 of this disclosure, the set of discharge nozzles 708 includes four discharge nozzles 708 regularly arranged about the discharge end of the nozzle head 702. The set of discharge nozzles 708 are canted to impart a jet reaction torque, i.e., rotation, on the nozzle head 702 and also on the tubular nozzle shaft 704, which makes the nozzle head 702 and the tubular nozzle shaft 704 self-rotating. The direction of self-rotation in this illustrated embodiment is clockwise when looking into the discharge end of the nozzle assembly 700. The direction of rotation helps to maintain the nozzle head 702 screwed securely into the tubular nozzle shaft 704.

Pressurized liquid introduced into the inlet end of the nozzle apparatus assembly 700, i.e., the end coupled to the high-pressure liquid input source, is discharged from the nozzle apparatus assembly 700 from the set of discharge nozzles 708 of the nozzle head 702. Liquid may also escape from the nozzle apparatus assembly 700 from one or more of the weep passages, e.g., weep passages 710 and 712, due to failure of an O-ring, a loose inlet connection, etc. As explained in more detail below, the discharge port 714 provides an outlet for pressurized liquid flowing through a secondary fluid flow path 709, shown and described in FIG. 11. The secondary fluid flow path 709 is configured to reduce the mechanical wear at the rotational interfaces by containing thin fluid films providing decreased pressure at the rotational interfaces, as shown and described in FIG. 12.

With reference now to the cross-sectional view of the nozzle apparatus assembly 700 depicted in FIG. 8, the nozzle head 702 is shown fixedly mounted to the tubular nozzle shaft 702, which is in turn rotatably mounted within the housing 706 on a set of bearings, e.g., bearings 718A and 718B (referred to collectively as “bearings 718”). The axial position of the bearing 718A is maintained by a stepwise annular shoulder formed on the tubular nozzle shaft 704 and the inside surface of the cap 716 that seals the discharge end of the housing body 706. The bearing 718A is located between seals 720A and 720B, which are positioned to prevent the inflow of cleaning fluid from contacting and fouling the bearing 718A and/or prevent the outflow of lubricating fluid from the nozzle assembly apparatus 700. The axial position of bearing 718B is maintained by a stepped annular shoulder formed in outer sidewall of the tubular nozzle shaft 704 and a shaft cap 727. The bearing 718B is located between seals 722A and 722B, which are positioned to prevent the inflow of cleaning fluid from contacting and fouling the bearing 718B and/or prevent the outflow of lubricating fluid from the nozzle assembly apparatus 700.

In another embodiment, the nozzle apparatus assembly 700 can be formed without one or more of the seals to permit fluid throughout the interior of the housing 706. For example, the nozzle apparatus assembly can be packed with lubricating fluid and the omission of seals 720B and 722A (as well as the seal retainer 719) can permit the flow of lubricant throughout the housing 706 to lubricate bearings 718A and 718B, as well as the components of the friction brake assembly 800. In another embodiment, one or more other seals can be omitted to allow leak water to penetrate the interior of housing 706 to cool brake disks 804.

Mounted within the housing 706 and disposed around the tubular nozzle shaft 704 is a friction brake assembly 800 configured to reduce the rotational speed of the nozzle head 702 and tubular nozzle shaft 704 by converting a centrifugal force into an axial force. The axial force can then be used to increase the frictional forces applied to one or more brake disks 804 of the friction brake assembly 800. The friction brake assembly 800 is generally formed from a set of centrifugal force converters 802 and a set of brake disks 804. Positioning of the friction brake assembly 700 within the housing 706 can be maintained by an optional disk spacer 721, which can be omitted if not needed.

In the depicted embodiment, the set of centrifugal force converters 802 includes one centrifugal force converter 802 and the set of brake disks 804 includes a plurality of rotor disks 1600 and lined friction disks 1500 arranged in alternating fashion. The centrifugal force converter 802 are slidably engaged to the tubular nozzle shaft 704 but rotationally fixed relative to the tubular nozzle shaft 704 so that the rotation of the tubular nozzle shaft 704 causes the centrifugal force converter 802 to rotate in concert with the tubular nozzle shaft 704. At least some of the brake disks 804, e.g., rotor disks 1600, are also slidably engaged to the tubular nozzle shaft 704 and rotationally fixed relative to the tubular nozzle shaft 704 so that at least some of the brake disks 804 can rotate in concert with the tubular nozzle shaft 704. The remaining portion of the brake disks 804, e.g., lined friction disks 1500, are coaxially aligned about the tubular nozzle shaft 704 but slidably engaged to the housing body 300 and rotationally fixed relative to the housing body 300. By allowing some of the brake disks 804 to rotate with the rotating tubular nozzle shaft 704 while the remaining brake disks 804 are maintained rotationally fixed, the amount of friction between the brake disks 804 can be increased in order to generate a braking force to slow down the rotation of the tubular nozzle shaft 704 and the nozzle head 702.

Each of the centrifugal force converters 802 is formed from one or more centrifugally responsive weights 806 that travels radially outwardly along the surface of an idler spider 1700 in the presence of a centrifugal force. In the depicted embodiment, the centrifugally responsive weights 806 are ball bearings formed from a dense material, such as metal or a metallic alloy. As the ball bearings travel radially outwardly, the ramped disk 1400 engages the ball bearings to convert at least some of the centrifugal force of the ball bearings into an axial force that compresses the brake disks 804, which reduces the rate of rotation of the tubular nozzle shaft 204 and the attached nozzle head 202. Heat generated by the frictional forces between the brake disks 804 can be drawn away by heat sink 805, which is positioned between the brake disks 804 and a shoulder the tubular nozzle shaft 704. The operational principles of the friction brake assembly 800 is described in more detail in U.S. Application No. 63/619,625, which is incorporated by reference herein. The friction brake assembly 800 can be replaced in favor of a different braking system, such as fluid brake assembly, as described in more detail in U.S. Application No. 63/610,309, incorporated by reference herein, or omitted entirely.

A source of pressurized liquid, e.g., a fluid hose or lance, (not shown) can be coupled to the inlet end of the housing body 706 by conventional means, including but not limited to a cone-and-thread connector or conventional pipe threads. In the non-limiting embodiment in FIG. 8, the nozzle apparatus assembly 700 includes a sleeve 724 that provides a connection interface with the source of pressurized liquid. The sleeve 724 is shown having a smooth, conical surface configured to engage a cone-and-thread connector but can take any one or more different configurations in alternate embodiments.

Pressurized liquid introduced into the nozzle apparatus assembly 700 via the sleeve 724 is conveyed through a primary flow path 707 that extends through the tubular nozzle shaft 704, and through passages formed in the nozzle head 702 before being discharged through the discharge nozzles 708. The discharge of the pressurized liquid from the canted discharge nozzles 708 causes nozzle head 702 and tubular nozzle shaft 704 to rotate. At high operating pressures, the nozzle head 702 and tubular nozzle shaft 704 can rotate at high speeds, e.g., 5,000 RPMs or more, resulting in mechanical wear at the rotational interfaces. The mechanical wear can be reduced by friction brake assembly 800 and by fluid carried through the secondary fluid flow path 709.

The secondary fluid flow path 709, shown in more detail in FIG. 11, extends from the upstream end of the sleeve 724, between the sleeve 724 and the stem 705, between the sleeve 724 and the mechanical seal 900, and out of the nozzle assembly apparatus 700 from the discharge port 714. Pressurized liquid introduced through the sleeve 724 and conveyed through the secondary fluid flow path 709 forms thin fluid films between the sleeve 724 and the stem 705 and also between the sleeve 724 and the mechanical seal 900 to reduce frictional engagement of the surfaces at their respective rotational interfaces. Additionally, the pressurized liquid flowing through the secondary fluid flow path 709 has a generally decreasing pressure gradient along its length, resulting in at least the rotational interface between the mechanical seal 900 and the sleeve 724 being exposed to lower operating pressures, which prolongs the service life of the nozzle apparatus assembly 700.

The sleeve 724 is generally cylinder-shaped with a flared upstream end that engages a shoulder of the housing body 706 to limit axial movement. The sleeve 724 is engaged around a portion of the tubular nozzle shaft 704. In the non-limiting embodiment depicted in FIGS. 7-12, the tubular nozzle shaft 704 includes a narrower stem 705 that receives the sleeve 724. The stem 705 is shown to be removably attached to the tubular nozzle shaft 704, but in another embodiment the stem 705 can be integrally formed with or fixedly attached to the tubular nozzle shaft 704.

To mitigate the effects of mechanical wear at the rotational interface between the sleeve 724 and the mechanical seal 900, the mechanical seal 900 is slidably engaged around the nozzle shaft 705, i.e., stem 705, and biased towards the downstream end wall of the sleeve 724 by a wave spring 725 that is shielded by a shaft cap 727 engaged around the nozzle shaft 704. During operation, the spring force of the wave spring 725, along with a fluid pressure exerted against the downstream end wall of the mechanical seal 900 overcomes the upstream pressure exerted against the upstream end wall of the mechanical seal 900, urging the mechanical seal 900 towards the sleeve 724 to maintain the gap distance between the two surfaces despite the presence of mechanical wear. The mechanical seal 900 can ride on a thin fluid film on a branch of the secondary fluid flow path 709, as described in more detail below.

With reference to FIG. 11, an enlarged, cross-sectional view of an inlet end of the nozzle apparatus assembly 700 is depicted. A pressurized cleaning fluid, represented by arrow 500, can be provided by a high-pressure liquid input source (not shown) coupled to the sleeve 724. The cleaning fluid can be introduced at a pressure between about 2,000 PSI-55,000 PSI. The portion of the pressurized cleaning fluid traveling through the primary fluid flow path 707 discharged through the discharge nozzles 708 causes the tubular nozzle shaft 704 and the nozzle head 702 to rotate at a high rate of speed. The remaining portion of the pressurized cleaning fluid traveling through the secondary fluid flow path 709 is discharged through the discharge port 714 and forms a first thin fluid film, represented by arrow 502 in FIG. 12, in gap 1202 and a second thin fluid film, represented by arrow 504 in FIG. 12, in gap 1204. The pressure drop along the secondary fluid flow path 709, shown in the figure that follows, reduces the amount of pressure exerted at the rotational interfaces, e.g., between the mechanical seal 900 and sleeve 724, which reduces mechanical wear.

The secondary fluid flow path 709 also includes a branch, represented by the double headed arrow 709′, which has a constant (or near constant) pressure along its length. The branch of the secondary fluid flow path 709 is coextensive with the thin fluid film formed in the gap 1206, which is represented by the double-headed arrow 506 in FIG. 12.

FIG. 12 is an enlarged, cross-sectional view of the inlet end of the tubular nozzle shaft 704 showing the sleeve 724 engaged around the stem 705 and in facing engagement with mechanical seal 900. Pressurized liquid is introduced into the nozzle apparatus assembly 700 at the sleeve 724 at a first pressure P1. The portion of the pressurized liquid flowing through the secondary fluid flow path 709 exerts a pressure of about Pl on the upstream end wall of the sleeve 724. As the pressurized liquid travels through the gap 1202 between the stem 705 and the sleeve 724, the pressure decreases to a second pressure P2 at the transition between the first thin fluid film 502 and the second thin fluid film 504. The pressure of the pressurized liquid continues to decrease radially outwardly as it is conveyed through the gap 1204 between the sleeve 724 and the mechanical seal 900 and achieves a third pressure P3 before exiting from the discharge port 714. In a non-limiting embodiment where the inlet pressure P1 is about 40,000 PSI, the second pressure P2 is about 25,000 PSI, and the third pressure is about atmospheric pressure, i.e., 14.7 PSI.

The spring-biased mechanical seal 900 permits for greater manufacturing tolerances so that the width of gaps 1202 and 1204 can be greater than the width of gaps 602 and 604 in the embodiment depicted and described in FIGS. 1-6.

The tubular nozzle shaft 704 can include a plurality of recesses 748 spaced apart along the stem 705, which promotes non-laminar fluid flow in the gap 1202 between the stem 705 and the sleeve 724, which reduces the drag along the surfaces between the stem 705 and the sleeve 724. In the depicted embodiment, the plurality of recesses 748 are annular recesses, but can take a different shape in other embodiments, e.g., dimpled shape like the exterior surface of golf balls.

### Third Illustrative Embodiment

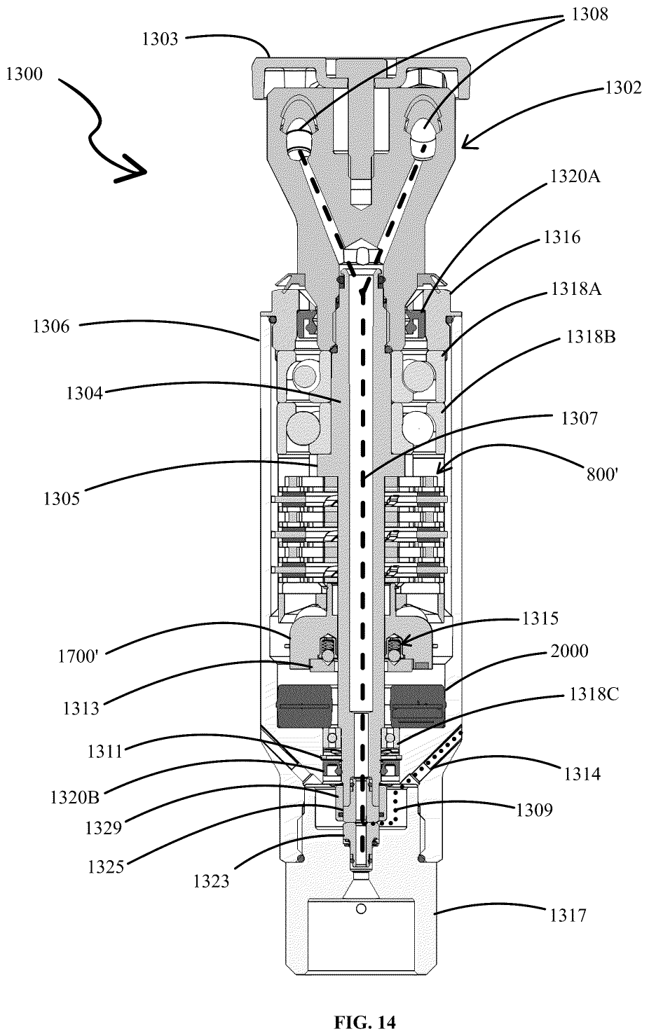

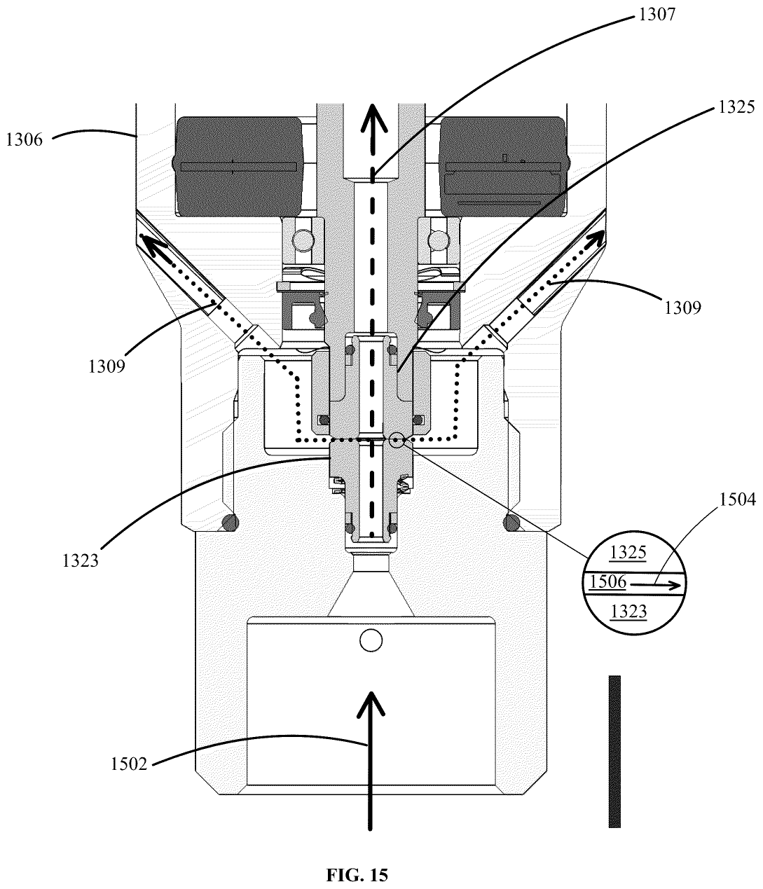

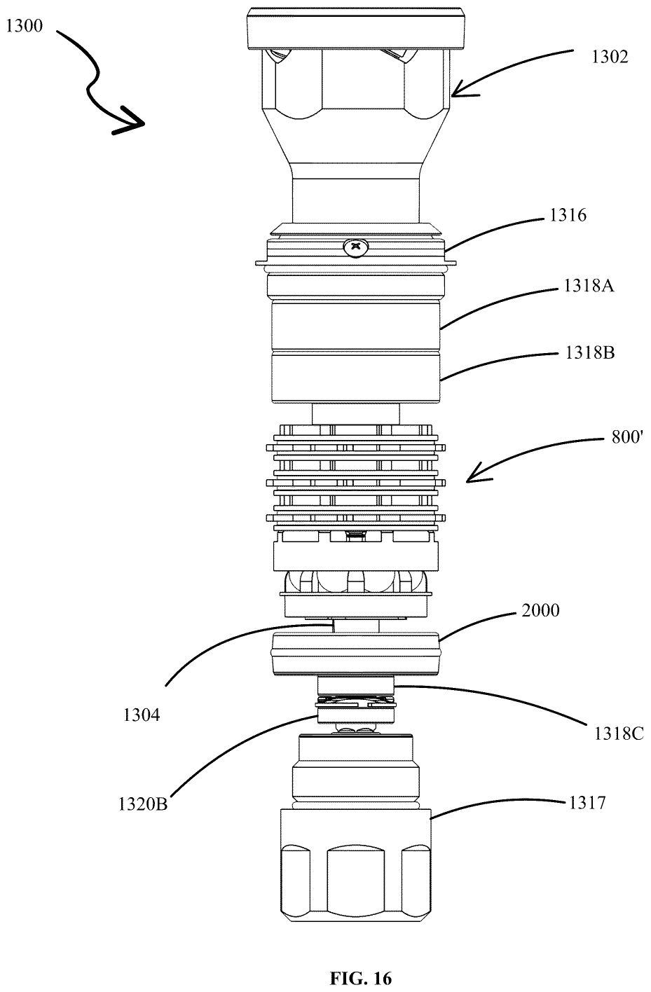

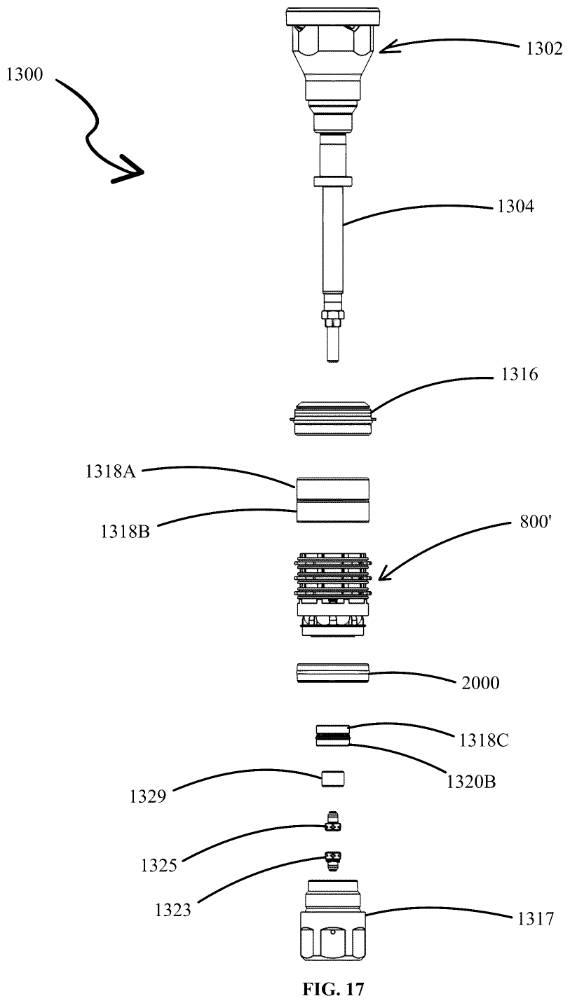

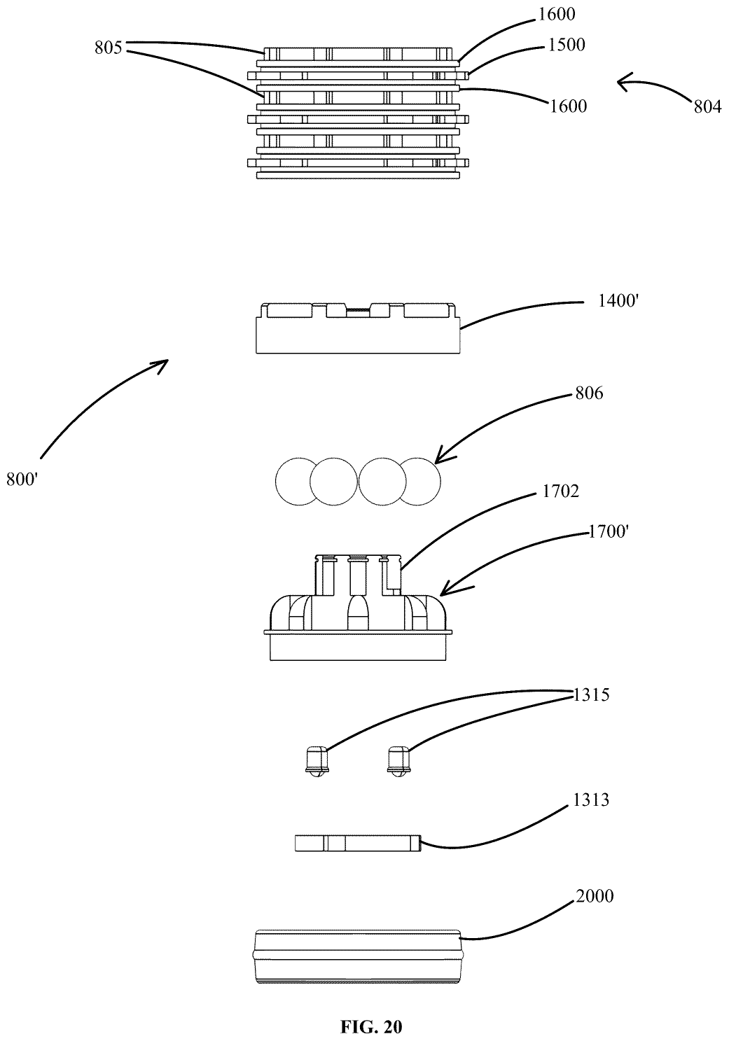

FIGS. 13-22 depict the nozzle apparatus assembly 1300 according to another illustrative embodiment. In particular, FIG. 13 is a perspective view of the nozzle apparatus assembly 1300. FIG. 14 is a cross-sectional view of the nozzle apparatus assembly 1300 of FIG. 13, taken along line 14-14. FIG. 15 is an enlarged, cross-sectional view of an inlet end of the nozzle apparatus assembly 1300 from FIG. 14. FIG. 16 illustrates a side view of the nozzle apparatus assembly 1300, but with the housing removed. FIGS. 17-19 are exploded, perspective views of the nozzle apparatus assembly 1300 in FIG. 16, and FIGS. 20-22 are exploded, perspective views of the braking assembly and data logger of the nozzle apparatus assembly 1300.

The exemplary nozzle apparatus 1300 depicted in FIG. 13-19 includes an elongated cylindrical housing body 1306, within which is rotatably mounted a tubular nozzle shaft 1304 that is shown in more detail in FIGS. 14 and 17-19. The tubular nozzle shaft 1304 is securely attached to a nozzle head 1302 so that rotation of the nozzle head 1302 causes rotation of the tubular nozzle shaft 1304. Rotation of the nozzle head 1302 is caused by the discharge of pressurized liquid, i.e., jet streams, from a set of canted discharge nozzles 1308. In the non-limiting embodiment presented in FIGS. 13-19 of this disclosure, the set of discharge nozzles 1308 includes four discharge nozzles 1308 regularly arranged about the discharge end of the nozzle head 1302 but can include a fewer number of nozzles or a greater number of nozzles. The set of discharge nozzles 1308 are canted to impart a jet reaction torque, i.e., rotation, on the nozzle head 1302 and also on the tubular nozzle shaft 1304, which makes the nozzle head 1302 and the tubular nozzle shaft 1304 self-rotating. The direction of self-rotation in this illustrated embodiment is clockwise when looking into the discharge end of the nozzle assembly 1300. The direction of rotation helps to maintain the nozzle head 1302 screwed securely into the tubular nozzle shaft 1304.

Pressurized liquid introduced into the inlet end of the nozzle apparatus assembly 1300 is discharged from the nozzle apparatus assembly 1300 from the set of discharge nozzles 1308 of the nozzle head 1302. In the depicted embodiment in FIG. 13, the nozzle head 1302 includes a head cap 1303 secured over the discharge end of the nozzle head 1302. The head cap 1303 includes a set of apertures 1327, each of which coincides with one of the discharge nozzles 1308. In the depicted embodiment, each of the set of apertures 1327 are elliptical to accommodate the angle of the water jet discharged from the set of discharge nozzles 1308.

Liquid may also escape from the nozzle apparatus assembly 1300 from one or more of the weep passages (not shown), due to failure of an O-ring, a loose inlet connection, etc. Some of the pressurized fluid can also escape from the nozzle apparatus assembly 1300 via discharge ports 1314, which provides an outlet for pressurized liquid flowing through a secondary fluid flow path 1309 that is shown in more detail in FIGS. 14 and 15. The secondary fluid flow path 1309 is configured to reduce the mechanical wear at the rotational interfaces between a pair of flat face labyrinth seals 1323 and 1325, shown in more detail in FIGS. 14 and 15 below. The flat face labyrinth seals 1323 and 1325 reduce mechanical wear by containing a thin fluid film at their rotational interface and by providing decreased pressure at the rotational interface in a manner that was previously described, and which will be omitted here for the sake of brevity.

With reference now to the cross-sectional view of the nozzle apparatus assembly 1300 depicted in FIG. 14, the nozzle head 1302 is shown fixedly mounted to the tubular nozzle shaft 1304, which is in turn rotatably mounted within the housing 1306 on a set of bearings, e.g., bearings 1318A, 1318B, 1318C (referred to collectively as “bearings 1318”). The axial position of bearings 1318A and 1318B is maintained by an annular shoulder 1305 formed on the tubular nozzle shaft 1304 and the inside surface of the cap 1316 that seals the discharge end of the housing body 1306. The axial position of bearing 1318C is maintained by an internal retaining ring 1311 and a stepwise annular shoulder formed on the nozzle shaft 1304. The bearing 1318C can be separated from the retaining ring 1311 by a wave spring that can bias the bearing 1318C against the shoulder of the nozzle shaft 1304 at its inlet end.

The set of bearings 1318 are located between seals 1320A and 1320B (collectively, seals 1320, which are positioned to prevent the inflow of cleaning fluid from contacting and fouling the set of bearing 1318 and the friction braking assembly 800′, and/or prevent the outflow of lubricating fluid from the nozzle assembly apparatus 1300. In another embodiment, the nozzle apparatus assembly 1300 can be formed without one or more of the seals to permit fluid flow throughout the interior of the housing 1306. For example, the omission of one or more of the seals, e.g., seals 1320, can permit leak water to penetrate the interior of housing 1306 to cool brake disks 804.

Mounted within the housing 1306 and disposed around the tubular nozzle shaft 1304 is a friction brake assembly 800′, shown and described in more detail in FIGS. 20-22, which is configured to reduce the rotational speed of the nozzle head 1302 and tubular nozzle shaft 1304 by converting a centrifugal force into an axial force. The axial force can then be used to increase the frictional forces applied to one or more brake disks 804 of the friction brake assembly 800′. The friction brake assembly 800′ is generally formed from a set of centrifugal force converters 802′, which includes a ramped disk 1400′, centrifugally responsive weights 806, and an idler spider 1700′, and a set of brake disks 804. An axial position of the friction brake assembly 800′ within the housing 1306 can be maintained by the annular shoulder 1305 formed on the tubular nozzle shaft 1304 which abuts against the bearing 1318B and an adjuster nut 1313 that is secured around the nozzle shaft 1304. In a non-limiting embodiment, the adjuster nut 1313 is secured around the nozzle shaft 1304 at a threaded interface (not shown) that allows the adjuster nut 1313 to travel along the nozzle shaft 1304 by the application of a rotational force, which provides an adjustable buttress for the friction brake assembly 800′ for controlling the initial amount of compressive force between the components of the friction brake assembly 800′ at rest.

In a non-limiting embodiment, the friction brake assembly 800′ engages the adjuster nut 1313 through a set of ball nose spring plungers 1315 disposed between the adjuster nut 1313 and the idler spider 1700′. The set of ball nose spring plungers 1315 are partially recessed within blind bores formed in the base of the idler spider 1700′ with at least its rounded end exposed. The rounded end of the ball nose spring plungers 1315 engage a dimpled surface of the adjuster nut 1313, which can provide audible and tactile feedback as the adjuster nut 1313 is rotated about the nozzle shaft 1304. The ball nose spring nose plungers 1315 can eliminate or at least reduce the likelihood that the adjuster nut 1313 will self-rotate during operation of the nozzle apparatus assembly 1300, and can also provide a limited degree of axial travel of the friction brake assembly 800′.

A source of pressurized liquid, e.g., a fluid hose or lance, (not shown) can be coupled to the inlet end of the housing body 1306 by conventional means, including but not limited to a cone-and-thread connector or conventional pipe threads. In the non-limiting embodiment in FIG. 14, the nozzle apparatus assembly 1300 includes an inlet nut 1317 attached to the inlet end of the housing 1306. The inlet nut 1317 provides a connection interface with a terminal end of the source of pressurized liquid. For example, the inlet nut 1317 can include an inlet seat having a smooth, conical interface configured to engage a cone-and-thread connector but can take any one or more different configurations in alternate embodiments.

Pressurized liquid introduced into the nozzle apparatus assembly 1300 via the connection interface of the inlet nut 1317 is conveyed through a primary flow path 1307 that extends through the tubular nozzle shaft 1304, and through passages formed in the nozzle head 1302 before being discharged through the discharge nozzles 1308. The discharge of the pressurized liquid from the canted discharge nozzles 1308 causes nozzle head 1302 and tubular nozzle shaft 1304 to rotate. At high operating pressures, the nozzle head 1302 and tubular nozzle shaft 1304 can rotate at high speeds, e.g., 5,000 RPMs or more, resulting in mechanical wear at the rotational interfaces, e.g., between the faces of the flat face labyrinth seals 1323 and 1325. For example, the upstream flat face labyrinth seal 1323 is fixed relative to the inlet nut 1317 and the housing 1306 and does not rotate during operation of the nozzle apparatus assembly 1300. The downstream flat face labyrinth seal 1325 is fixed relative to the inlet end of the nozzle shaft 1304, secured bv a keeper ring 1329, which causes it to rotate with the nozzle shaft 1304 during operation. The mechanical wear between the faces of the labyrinth seals 1323 and 1325 can be reduced by fluid carried through the secondary fluid flow path 1309 that travels through a space between a pair of flat face labyrinth seals 1323 and 1325.

The secondary fluid flow path 1309, shown in more detail in FIG. 15, extends from the primary fluid flow path 1307, between a downstream flat face labyrinth seal 1323 and an upstream flat face labyrinth seal 1325, and then out through a set of forward-facing discharge ports 1314 passing through the housing 1306. The forward-facing discharge ports 1314 are directed towards the discharge end of the nozzle apparatus assembly 1300 to minimize the likelihood of injury to operators from pressurized water.

Pressurized liquid introduced through the inlet seat and conveyed through the secondary fluid flow path 1309 forms thin fluid films between the pair of flat face labyrinth seals 1323 and 1325 to reduce frictional engagement of the surfaces at their respective rotational interfaces. Additionally, the pressurized liquid flowing through the secondary fluid flow path 1309 has a generally decreasing pressure gradient with increasing radial distance from the primary fluid flow path 1307, resulting in at least the rotational interface between the pair of flat face labyrinth seals 1323 and 1325 being exposed to lower operating pressures, which prolongs the service life of the nozzle apparatus assembly 1300. The upstream flat face labyrinth seal 1325 can be biased towards the downstream flat face labyrinth seal 1325, e.g., by a wave spring, which can maintain the gap between the two faces of the flat face labyrinth seals 1323 and 1325. In the embodiment of the nozzle apparatus assembly 1300 described in this disclosure, the wave spring is disposed between an annular shoulder of the upstream flat face labyrinth seal 1323 and a corresponding annular shoulder of the inlet nut 1317. The gap size at the rotational interface between the upstream flat face labyrinth seal 1323 and the downstream flat face labyrinth seal 1325 can be controlled by selecting a spring with a known spring constant that can bias the upstream flat face labyrinth seal 1323 towards the downstream flat face labyrinth seal 1325 during operating conditions. In another embodiment, the wave spring can be placed behind the downstream flat face labyrinth seal 1325 instead to bias the downstream flat face labyrinth seal towards the upstream flat face labyrinth seal 1323.

With reference to FIG. 15, an enlarged, cross-sectional view of an inlet end of the nozzle apparatus assembly 1300 is depicted. A pressurized cleaning fluid, represented by arrow 1502, can be provided by a high-pressure liquid input source (not shown) coupled to the inlet seat of the inlet nut 1317. The cleaning fluid can be introduced at a pressure between about 1,000 PSI-55,000 PSI. The portion of the pressurized cleaning fluid traveling through the primary fluid flow path 1307 discharged through the discharge nozzles 1308 causes the tubular nozzle shaft 1304 and the nozzle head 1302 to rotate at a high rate of speed. The remaining portion of the pressurized cleaning fluid traveling through the secondary fluid flow path 1309 is discharged through the discharge port 1314 and forms a first thin fluid film, represented by arrow 1504 in FIG. 15, in gap 1506. The pressure drop along the secondary fluid flow path 1309 reduces the amount of pressure exerted at the rotational interfaces.

The dimensions of the gap between the rotational surfaces allows for the formation of a thin fluid film 1504, to reduce the amount of contact between surfaces at rotational interfaces, which reduces the mechanical wear of the nozzle apparatus assembly 1300. Further, the decreased water pressure at the rotational interfaces also reduces mechanical wear.

FIGS. 20-22 depict various views of the friction brake assembly 800′ and datalogger 2000 according to an illustrative embodiment. The friction brake assembly 800′ operates according to the same principles as the friction brake assembly 800 implemented in nozzle apparatus assembly 700, the detailed discussion of which will be omitted for the sake of brevity. However, the idler spider 1700′ is modified to include an elongated neck 1702 that encircles the shaft 1304 of the nozzle apparatus assembly 1300, and the ramped disk 1400′ is keyed to cause the ramped disk 1400′ to rotate with the idler spider 1700′, but allow it to slidably engage the outer surface of the elongated neck 1702 in an axial direction. A removable snap ring can be fitted to the end of the elongated neck 1702 to prevent the ramped disk 1400′ sliding off the end of the elongated neck 1702. By securing the ramped disk 1400′ onto the elongated neck 1702, the centrifugally responsive weights 806 can be captured between the idler spider 1700′ and the ramped disk 1400′, which prevents the centrifugally responsive weights 806 from escaping during assembly, disassembly, and servicing of the nozzle apparatus assembly 1300. Rotational motion causes the centrifugally responsive weights 806 to travel radially outwardly along the base of the idler spider 1700′ while also engaging the curved surface of the ramped disk 1400′. Because a distance between the curved surface of the ramped disk 1400′ and the opposing surface of idler spider 1700′ generally decreases as a radial distance from the nozzle shaft 1304 increases, as the centrifugally responsive weights 806 travel radially outwardly, the ramped disk 1400′ is forced to travel towards the discharge end of the nozzle apparatus assembly 1300 and transforms at least some of the centrifugal force into an axial braking force. Although the operative surface of the ramped disk 1400′ is described as a curved surface, in another embodiment the operative surface can be a ramped surface with a constant or substantially constant slope, or a combination of a curved surface and a ramped surface. For the sake of simplicity, the curved surface and/or ramped surface of the ramped disk 1400′ may be referred to more generally as the operative surface of the ramped disk 1400′. In addition or in the alternative, the idler spider 1700′ can also include an operative surface that is at least partially curved, at least partially ramped, or both.

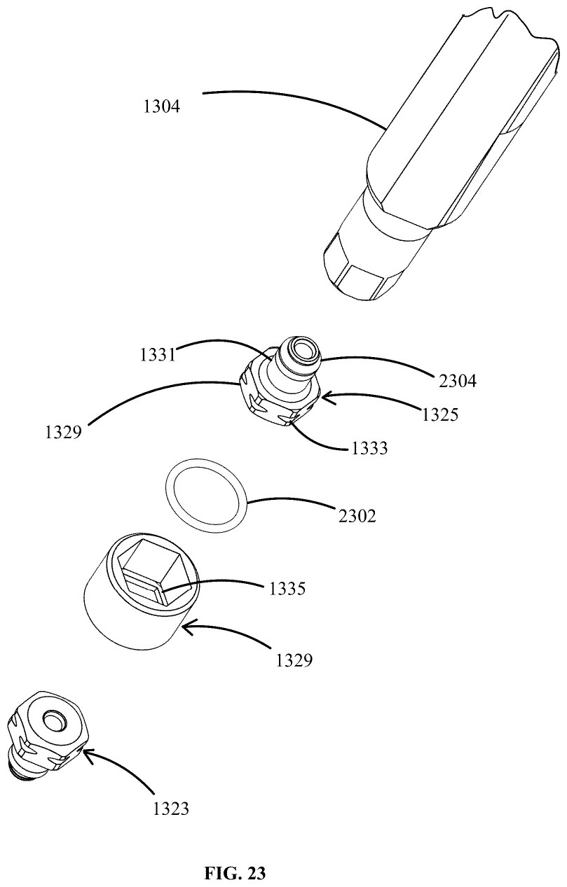

FIG. 23 is a partially exploded view of the inlet end of the nozzle shaft 1304, the keeper ring 1329, and the flat face labyrinth seals 1323 and 1325 in accordance with an illustrative embodiment. The downstream flat face labyrinth seal 1325 is clocked to the nozzle shaft 1304 by the keeper ring 1329 so that the rotation of the nozzle shaft 1304 also causes the downstream flat face labyrinth seal 1325 to rotate. In the non-limiting embodiment in FIG. 23, the outer surface of the inlet end of the nozzle shaft 1304 has a shape that is analogous to the outer surface of the head portion 1333 of the downstream flat face labyrinth seal, both of which are keyed to the shape of the inner surface of the keeper ring 1329. In FIG. 23, the outer surface of the inlet end of the nozzle shaft 1304 and the head portion 1333 of the downstream flat face labyrinth seal 1325 have a hexagonal shape that can be sized to be received by a standard socket. The inner surface of the keeper ring 1329 also has a complementary hexagonal shape that can be slidably inserted over the downstream flat face labyrinth seal 1325 and the inlet end of the nozzle shaft 1304. The axial position of the keeper ring 1329 is maintained by an O-ring 2302 that is received within an engagement interface, e.g. an annular recess 1335, formed on the inner surface of the keeper ring 1329 and an engagement interface, e.g. a recess, formed on the exterior surface of the downstream flat face labyrinth seal 1325 and/or the exterior surface of the inlet end of the nozzle shaft 1304. In this illustrative embodiment, the recess is formed on the exterior surface of the head portion 1333 of the downstream flat face labyrinth seal 1325.

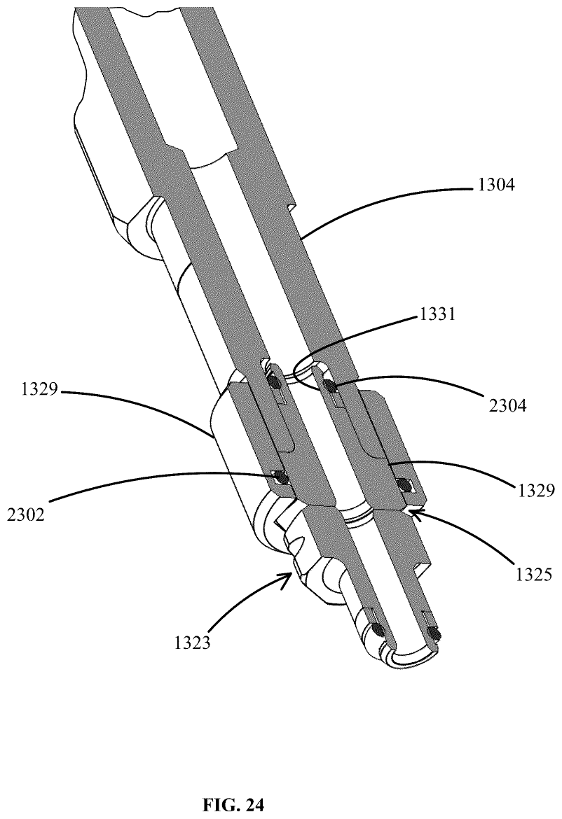

FIG. 24 is a cross-sectional view of the inlet end of the nozzle shaft, the keeper ring, and the flat face labyrinth seals in accordance with an illustrative embodiment, but in the installed configuration. Other components of the nozzle shaft assembly 1300 have been omitted for the sake of simplicity.

The neck portion 1331 of the downstream flat face labyrinth seal 1325 is shown received into inlet end of the nozzle shaft 1304. The keeper ring 1329 is secured around the downstream flat face labyrinth seal 1325 and the inlet end of the nozzle shaft 1304. An O-ring 2304 is engaged around the outside surface of the neck portion 1331 to control the flow of pressurized fluid. The placement of the O-ring 2304 reduces the likelihood of cracking of the downstream flat face labyrinth seal 1325 by allowing pressurized fluid to be present on both sides of the neck portion 1331 of the downstream flat face labyrinth seal 1325. In contrast, placement of the O-ring 2304 at the end of the downstream flat face labyrinth seal 1325 to produce a high-pressure side and a low-pressure side along the neck region 1331 of the flat face labyrinth seal 1325 causes cracking over time.

The base of the idler spider 1700′ includes a set of embedded magnets 1704 that can be used to generate a detectable change, e.g., a rotating magnetic field, within the nozzle apparatus assembly 1300 readable by a data logger 2000. The data logger 2000 positioned adjacent to the base of the idler spider 1700′ can include a sensor capable of detecting changes, e.g., the changing magnetic field, such as a Hall Effect sensor that can be used to capture rotational data of the nozzle apparatus assembly 1300. The operational principles of the data logger 2000 is described in more detail in U.S. Application No. 63/667,469, which is incorporated by reference herein.

For the purposes of the present disclosure, the term “a” or “an” entity refers to one or more of that entity. As such, the terms “a” or “an,” “one or more,” and “at least one” can be used interchangeably herein.

All numeric values herein are assumed to be modified by the term “about,” whether or not explicitly indicated. For the purposes of the present invention, ranges may be expressed as from “about” one particular value to “about” another particular value. It will be understood that the endpoints of each of the ranges are significant both in relation to the other endpoint and independently of the other endpoint. When a value is expressed as an approximation by use of the antecedent “about,” it will be understood that the particular value forms another embodiment.

Additionally, the section headings herein are provided for consistency with the suggestions under 37 C.F.R. § 1.77 or to provide organizational cues. These headings shall not limit or characterize the invention(s) set out in any claims that may issue from this disclosure. Specifically, and by way of example, although the headings refer to a “Technical Field,” the claims should not be limited by the language chosen under this heading to describe the so-called field. Further, a description of a technology as background information is not to be construed as an admission that a particular technology is prior art to any embodiment(s) in this disclosure. Neither is the “Summary” a characterization of the embodiment(s) outlined in issued claims.

Furthermore, any reference in this disclosure to “invention” in the singular should not be used to argue that there is only a single point of novelty in this disclosure. Multiple embodiments may be set forth according to the limitations of the multiple claims issuing from this disclosure. Such claims accordingly define the embodiment(s) and their equivalents that are protected thereby. In all instances, the scope of such claims shall be considered on their own merits in light of this disclosure but should not be constrained by the headings set forth herein.

Moreover, the Abstract is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the preceding Detailed Description, it can be seen that various features may be grouped in a single embodiment to streamline the disclosure. This method of disclosure is not to be interpreted as reflecting an intention that the claimed embodiments require more features than are expressly recited in each claim. Instead, as the claims reflect, the inventive subject matter lies in less than all features of a single disclosed embodiment. Thus, the following claims are incorporated into the Detailed Description, with each claim standing on its own as a separate embodiment.

What is claimed is:

1. A nozzle apparatus assembly comprising:
a housing body;
a nozzle head connected to a nozzle shaft rotatably mounted within the housing body, wherein:
the nozzle shaft and the nozzle head define a primary fluid flow path extending from an inlet end of the nozzle shaft to a set of directional nozzles disposed at a discharge end of the nozzle head, and
the nozzle shaft and the nozzle head are configured to rotate together in response to a pressurized liquid conveyed through the primary fluid flow path and discharged from the set of directional nozzles; and
a secondary fluid flow path in fluid communication with the primary fluid flow path, wherein the secondary fluid flow path passes between a rotational interface dimensioned to contain a thin fluid film with a pressure gradient that decreases radially outwardly.

2. The nozzle apparatus assembly of claim 1, further comprising a first flat face labyrinth seal engaged with a second flat face labyrinth seal at the rotational interface, wherein:
the inlet end of the nozzle shaft is rotationally fixed to the first flat face labyrinth seal, and
the second flat face labyrinth seal is slidably engaged within the nozzle apparatus, wherein the secondary fluid flow path is bounded, at least in part, by a face of the first flat face labyrinth seal and a face of the second flat face labyrinth seal.

3. The nozzle apparatus assembly of claim 2, further comprising:
a spring engaged with the second flat face labyrinth seal, wherein the spring biases the second flat face labyrinth seal towards the first flat face labyrinth seal.

4. The nozzle apparatus assembly of claim 3, further comprising:
an inlet nut coupled to an inlet end of the housing, wherein the spring is disposed between the second flat face labyrinth seal and the inlet nut.

5. The nozzle apparatus assembly of claim 2, further comprising:
a keeper ring, wherein an inner surface of the keeper ring is keyed to the inlet end of the nozzle shaft and the first flat face labyrinth seal to rotationally fix the first flat face labyrinth seal to the nozzle shaft.

6. The nozzle apparatus assembly of claim 5, wherein:
the keeper ring includes an engagement interface sized to receive an O-ring, and
at least one of the nozzle shaft or the first flat face labyrinth seal is configured to engage the O-ring to maintain an axial position of the keeper ring.

7. The nozzle apparatus assembly of claim 2, further comprising:
an O-ring disposed around a neck region of the first flat face labyrinth seal, wherein placement of the O-ring permits an inside surface and outside surface of the neck region to be exposed to a pressurized fluid having a substantially similar pressure.

8. The nozzle apparatus assembly of claim 1, further comprising:
a friction brake assembly housed within the housing body, wherein the friction brake assembly is configured to convert a centrifugal force generated by a rotation of the nozzle shaft and the nozzle head into an axial force that reduces a rate of rotation of the nozzle shaft and the nozzle head.

9. The nozzle apparatus assembly of claim 8, wherein the friction brake assembly includes at least one centrifugal force converter that comprises:
an idler spider;
a ramped disk; and
at least one centrifugally responsive weight disposed between the idler spider and the ramped disk, wherein rotation of the idler spider and the ramped disk by the nozzle shaft causes the at least one centrifugally responsive weight to travel radially outwardly along a surface of the idler spider and along an operative surface of the ramped disk.

10. The nozzle apparatus assembly of claim 9, wherein a distance between the operative surface of the ramped disk and the surface of the idler spider decreases as a radial distance from the nozzle shaft increases.

11. The nozzle apparatus assembly of claim 9, wherein the idler spider includes an elongated neck that encircles the nozzle shaft, and wherein the ramped disk is slidably engaged with the elongated neck.

12. The nozzle apparatus assembly of claim 8, further comprising:
an adjuster nut engaged with the nozzle shaft, wherein:
the adjuster nut is selectively positionable along a length of the nozzle shaft, and
an axial position of the friction brake assembly is controlled by a position of the adjuster nut on the nozzle shaft.

13. The nozzle apparatus assembly of claim 12, further comprising:
a set of ball nose spring plungers, wherein the friction brake assembly engages the adjuster nut through the set of ball nose spring plungers.

14. The nozzle apparatus assembly of claim 8, further comprising:
a data logger mounted to the housing body, wherein the data logger is configured to detect a rotational speed of the nozzle shaft and the nozzle head.

15. The nozzle apparatus assembly of claim 14, further comprising:
a set of magnets housed within the housing body, wherein:
the set of magnets is rotatable by the nozzle shaft and the nozzle head, and
the data logger detects the rotational speed of the nozzle shaft and the nozzle head based on a change of a magnetic field of the set of magnets.

16. The nozzle apparatus assembly of claim 1, wherein:
the nozzle shaft comprises a stem,
the nozzle apparatus further comprises a spool slidably engaged about the stem, and
the secondary fluid flow path is bounded, at least in part, by the spool.

17. The nozzle apparatus assembly of claim 16, wherein:
the stem projects from a shoulder of the nozzle shaft;
the secondary fluid flow path extends between the spool and the stem and between the spool and the shoulder or a seal retainer positioned between the spool and the shoulder,
the thin fluid film is contained in a gap between the spool and the shoulder or a gap between the spool and the seal retainer, and
a second thin fluid film is contained in a gap between the spool and the stem.

18. The nozzle apparatus assembly of claim 17, wherein:
the spool is rotationally fixed to the housing body, and the stem is configured to rotate within the spool.

19. The nozzle apparatus assembly of claim 1, wherein the nozzle shaft comprises a stem, and wherein the nozzle apparatus assembly further comprises:
a sleeve engaged around the stem, wherein the secondary fluid flow path is bounded, at least in part, by the sleeve.

20. The nozzle apparatus assembly of claim 19, wherein:
the secondary fluid flow path extends between the sidewall of the sleeve and the stem and between the sleeve and a mechanical seal biased towards the sleeve,
the thin fluid film is contained in a gap between the sleeve and the mechanical seal, and
a second thin fluid film is contained in a gap between the sleeve and the stem.

21. The nozzle apparatus assembly of claim 20, wherein:
the sleeve is rotationally fixed to the housing body, and
the stem is configured to rotate within the sleeve.
